(19) United States
(12) Patent Application Publication
(10) Pub. No.: US 2026/0028488 A1
(43) Pub. Date: Jan. 29, 2026

(54) ELECTRODEPOSITED COATINGS HAVING MULTIPLE RESIN DOMAINS

(71) Applicant: PPG Industries Ohio, Inc., Cleveland, OH (US)

(72) Inventors: Corey James DeDomenic, Trafford, PA (US); William Jay Keown, Cranberry Township, PA (US); Douglas Gordon Montjoy, Pittsburgh, PA (US); Xinzhu Gu, Allison Park, PA (US)

(73) Assignee: PPG Industries Ohio, Inc., Cleveland, OH (US)

(21) Appl. No.: 19/145,024

(22) PCT Filed: Nov. 6, 2023
(86) PCT No.: PCT/US2023/078765

§ 371 Date: Jul. 1, 2025

Related U.S. Application Data
(60) Provisional application No. 63/478,613, filed on Jan. 5, 2023.

(51) Int. Cl. C09D 5/44; C09D 7/40

(52) U.S. Cl. CPC C09D 5/4457; C09D 5/4438; C09D 7/70

(57) ABSTRACT

The present disclosure is directed to an electrodeposited coating or a coated metal substrate comprising the electrodeposited coating, wherein the electrodeposited coating comprises: a plate-like pigment present in a pigment-to-binder ratio of at least 0.4:1; and an electrodeposited binder comprising: a first resin domain having a first glass transition temperature; and a second resin domain having a second glass transition temperature, wherein the first glass transition temperature is at least 10° C., greater than the second glass transition temperature, and the second glass transition temperature is greater than −50° C., and/or the first glass transition temperature is at least 80° C. and the second glass transition temperature is from −50° C. to 70° C. Also disclosed are electrodepositable coating compositions and methods of coating substrates.

### FIELD

The present disclosure is directed towards an electrodepositable coating composition, an electrodeposited coating, coated substrates, and methods of coating substrates.

### BACKGROUND

Electrodeposition as a coating application method involves the deposition of a film-forming composition onto a conductive substrate under the influence of an applied electrical potential. Electrodeposition has gained popularity in the coatings industry because it provides higher paint utilization, outstanding corrosion resistance, and low environmental contamination as compared with non-electrophoretic coating methods. Both cationic and anionic electrodeposition processes are used commercially.

### SUMMARY

The present disclosure provides an electrodeposited coating or a coated conductive substrate comprising the electrodeposited coating, wherein the electrodeposited coating comprises: a plate-like pigment present in a pigment-to-binder ratio of at least 0.4:1; and an electrodeposited binder comprising: a first resin domain having a first glass transition temperature; and a second resin domain having a second glass transition temperature, wherein the first glass transition temperature is at least 10° C., such as at least 20° C., such as at least 30° C., such as at least 40° C., such as at least 50° C., such as at least 60° C., such as at least 70° C., such as at least 80° C., such as at least 90° C., such as at least 100° C., such as at least 110° C., such as at least 120° C. greater, such as at least 130° C., such as at least 140° C., such as at least 150° C., such as at least 160° C., such as at least 170° C. greater than the second glass transition temperature, and the second glass transition temperature is greater than −50° C.

The present disclosure also provides an electrodeposited coating or a coated conductive substrate comprising the comprising the electrodeposited coating, wherein the electrodeposited coating comprises: a plate-like pigment present in a pigment-to-binder ratio of at least 0.4:1; and an electrodeposited binder comprising: a first resin domain having a first glass transition temperature of at least 80° C.; and a second resin domain having a second glass transition temperature of from −50° C. to 70° C.

The present disclosure further provides an electrodepositable coating composition comprising: an electrodepositable binder comprising an active hydrogen-containing, ionic salt group-containing film-forming polymer; a curing agent; and at least one organic resinous component different than the active hydrogen-containing, ionic salt group-containing film-forming polymer and curing agent; and a plate-like pigment present in a pigment-to-binder ratio of at least 0.4:1.

The present disclosure also provides a method of coating a substrate comprising electrophoretically applying a coating deposited from an electrodepositable coating composition comprising: an electrodepositable binder comprising an active hydrogen-containing, ionic salt group-containing film-forming polymer; a curing agent; and at least one organic resinous component different than the active hydrogen-containing, ionic salt group-containing film-forming polymer and curing agent; and a plate-like pigment present in a pigment-to-binder ratio of at least 0.4:1, to at least a portion of the substrate.

### BRIEF DESCRIPTION OF THE DRAWING

FIG. 1 is a compilation of TEM images electrodeposited coatings described in Examples 1-5.

### DETAILED DESCRIPTION

The present disclosure is directed to an electrodeposited coating or a coated electrically conductive substrate comprising the comprising the electrodeposited coating, wherein the electrodeposited coating comprises: a plate-like pigment present in a pigment-to-binder ratio of at least 0.4:1; and an electrodeposited binder comprising: a first resin domain having a first glass transition temperature; and a second resin domain having a second glass transition temperature, wherein the first glass transition temperature is at least 10° C., such as at least 20° C., such as at least 30° C., such as at least 40° C., such as at least 50° C., such as at least 60° C., such as at least 70° C., such as at least 80° C., such as at least 90° C., such as at least 100° C., such as at least 110° C., such as at least 120° C. greater, such as at least 130° C., such as at least 140° C., such as at least 150° C., such as at least 160° C., such as at least 170° C. greater than the second glass transition temperature, and the second glass transition temperature is greater than −50° C.

The present disclosure is also directed to an electrodeposited coating or a coated electrically conductive substrate comprising the comprising the electrodeposited coating, wherein the electrodeposited coating comprises: a plate-like pigment present in a pigment-to-binder ratio of at least 0.4:1; and an electrodeposited binder comprising: a first resin domain having a first glass transition temperature of at least 80° C.; and a second resin domain having a second glass transition temperature of from −50° C. to 70° C.

The present disclosure is also directed to an electrodepositable coating composition comprising: an electrodepositable binder comprising an active hydrogen-containing, ionic salt group-containing film-forming polymer; a curing agent; and at least one organic resinous component different than the active hydrogen-containing, ionic salt group-containing film-forming polymer and curing agent; and a plate-like pigment present in a pigment-to-binder ratio of at least 0.4:1.

### Plate-Like Pigment

The electrodeposited coating and/or electrodepositable coating composition comprises a plate-like pigment present in a pigment-to-binder ratio of at least 0.4:1.

The plate-like pigment may be an inorganic plate-like pigment.

The plate-like pigment may be a phyllosilicate pigment. As used herein, the term “phyllosilicate” refers to a group of minerals having sheets of silicates having a basic structure based on interconnected six membered rings of SiO₄⁻⁴ tetrahedra that extend outward in infinite sheets where 3 out of the 4 oxygens from each tetrahedra are shared with other tetrahedra resulting in phyllosilicates having the basic structural unit of Si₂O₅⁻². Phyllosilicates may comprise hydroxide ions located at the center of the tetrahedra and/or cations such as, for example, Fe⁺², Mg⁺², or Al⁺³, that form cation layers between the silicate sheets where the cations may coordinate with the oxygen of the silicate layer and/or the hydroxide ions. The term “phyllosilicate pigment” refers to pigment materials comprising phyllosilicates. Non-limiting examples of phyllosilicate pigments include the micas, chlorites, serpentine, talc, and the clay minerals. The clay minerals include, for example, kaolin clay and smectite clay. The sheet-like structure of the phyllosilicate pigment tends to result in pigment having a plate-like structure, although the pigment can be manipulated (such as through mechanical means) to have other particle structures. These pigments when exposed to liquid media may or may not swell and may or may not have leachable components (e.g.: ions that may be drawn towards the liquid media).

The plate-like pigment may comprise a plate-like mica pigment, a plate-like chlorite pigment, a plate-like serpentine pigment, a plate-like talc pigment, and/or a plate-like clay pigment. The plate-like clay pigment may comprise kaolin clay, smectite clay, or a combination thereof.

The pigment component comprises a plate-like pigment which may have an average equivalent spherical diameter of at least 50 nm and up to 25 microns or higher. The average equivalent spherical diameter may be determined using dynamic light scattering, such as with a SEDIGRAPH III PLUS particle size analyzer, available from Micromeritics Instrument Corp. As plate-like particles the pigment often has substantially opposing surfaces and particles typically exhibit an aspect ratio of the longest axis to the shortest axis of, for example, at least 2:1. For example, the plate-like pigment may have an average equivalent spherical diameter of at least 50 nm, such as at least 0.2 microns, such as at least 0.4 microns, such as at least 0.6 microns, such as at least 1 micron, such as at least 2 microns, such as at least 3 microns, such as at least 4 microns, such as at least 5 microns. The plate-like pigment may have an average equivalent spherical diameter of no more than 25 microns, such as no more than 15 microns, such as no more than 10 microns, such as no more than 5 microns, such as no more than 3.5 microns, such as no more than 2.5 microns, such as no more than 1.9 microns, such as no more than 1.5 microns, such as no more than 1 microns.

The pigment-to-binder (P:B) ratio as set forth in this disclosure may refer to the weight ratio of the pigment-to-binder in the electrodepositable coating composition, and/or the weight ratio of the pigment-to-binder in the deposited wet film, and/or the weight ratio of the pigment to the binder in the dry, uncured deposited film, and/or the weight ratio of the pigment-to-binder in the cured film (i.e., the electrodeposited coating). The pigment-to-binder (P:B) ratio of the pigment to the electrodepositable binder may be at least 0.4:1, such as at least 0.5:1, such as at least 0.6:1, such as at least 0.75:1, such as at least 1:1, such as at least 1.25:1, such as at least 1.5:1. The pigment-to-binder (P:B) ratio of the pigment to the electrodepositable binder or electrodeposited binder may be no more than 2:1, such as no more than 1.75:1, such no more than 1.5:1, such as no more than 1.25:1, such as no more than 1:1, such as no more than 0.75:1, such as no more than 0.7:1, such as no more than 0.6:1, such as no more than 0.55:1, such as no more than 0.5:1. The pigment-to-binder (P:B) ratio of the pigment to the electrodepositable binder or electrodeposited binder may be 0.4:1 to 2:1, such as 0.4:1 to 1.75:1, such as 0.4:1 to 1.5:1, such as 0.4:1 to 1.25:1, such as 0.4:1 to 1:1, such as 0.4:1 to 0.75:1, such as 0.4:1 to 0.7:1, such as 0.4:1 to 0.6:1, such as 0.4:1 to 0.55:1, such as 0.4:1 to 0.5:1, such as 0.5:1 to 2:1, such as 0.5:1 to 1.75:1, such as 0.5:1 to 1.50:1, such as 0.5:1 to 1.25:1, such as 0.5:1 to 1:1, such as 0.5:1 to 0.75:1, such as 0.5:1 to 0.7:1, such as 0.5:1 to 0.6:1, such as 0.5:1 to 0.55:1, such as 0.6:1 to 2:1, such as 0.6:1 to 1.75:1, such as 0.6:1 to 1.5:1, such as 0.6:1 to 1.25:1, such as 0.6:1 to 1:1, such as 0.6:1 to 0.75:1, such as 0.6:1 to 0.7:1, such as 0.75:1 to 2:1, such as 0.75:1 to 1.75:1, such as 0.75:1 to 1.5:1, such as 0.75:1 to 1.25:1, such as 0.75:1 to 1:1, such as 1:1 to 2:1, such as 1:1 to 1.75:1, such as 1:1 to 1.5:1, such as 1:1 to 1.25:1, such as 1.25:1 to 2:1, such as 1.25:1 to 1.75:1, such as 1.25:1 to 1.5:1, such as 1.5:1 to 2:1, such as 1.5:1 to 1.75:1.

### Resin Domains

As used herein, the terms “resin domain” in first resin domain or second resin domain refers to a visible disruption in the homogeneity of the binder. The visible disruption may be visible using TEM and/or SEM. For example, the first resin domain may be the bulk resin and the second resin domain may be present as resinous areas that are phase separate from the bulk resin. For example, the second resin domain may be dispersed pockets of resin dispersed throughout the bulk resin of the first resin domain. The dispersed pockets of resin may have any geometric shape or morphology, such as, for example, spherical, lamellar, cylindrical, etc. The dispersed pockets may be generally uniformly dispersed or may be inconsistently dispersed. The dispersed pockets may also be stratified throughout the bulk resin. Alternatively, the first resin domain and second resin domain may be phase separated into a bi-layer configuration wherein one of the resin domains is present on the substrate surface and the other resin domain is present on top of that domain. The resin domain may be generally free of the plate-like pigment.

As mentioned above, the visible disruption may be visible using TEM. The identification of a second resin domain may be determined according to the following method, which will be referred to herein at the TEM ANALYSIS METHOD: Coated and cured panels are cut down to size and embedded in EMBed-812 epoxy and cured at 60° C. for 24 hrs. Thin sections (<80 nm) are then ultra-microtomed and collected on Cu TEM grids. Brightfield images are taken on a Tecnai T20 TEM operating at 200 kV. Visible resin domains may be identified in the resulting TEM image. Further image analysis may be performed to determine the size of the resin domain, as discussed in the examples section below.

The first resin domain has a first glass transition temperature, and the second resin domain has a second glass transition temperature. The first glass transition temperature may be at least 10° C., such as at least 20° C., such as at least 30° C., such as at least 40° C., such as at least 50° C., such as at least 60° C., such as at least 70° C., such as at least 80° C., such as at least 90° C., such as at least 100° C., such as at least 110° C., such as at least 120° C. greater, such as at least 130° C., such as at least 140° C., such as at least 150° C., such as at least 160° C., such as at least 170° C. greater than the second glass transition temperature, and the second glass transition temperature is greater than −50° C.

The first glass transition temperature may be at least 80° C., such as at least 90° C., such as at least 100° C., such as at least 110° C., such as at least 120° C., such as at least 125° C. The first glass transition temperature may be no more than 130° C., such as no more than 120° C., such as no more than 110° C., such as no more than 100° C., such as no more than 90° C. The first glass transition temperature may be from 80° C. to 130° C., such as 80° C. to 120° C., such as 80° C. to 110° C., such as 80° C. to 100° C., such as 80° C. to 90° C., such as 90° C. to 130° C., such as 90° C. to 120° C., such as 90° C. to 110° C., such as 90° C. to 100° C., such as 100° C. to 130° C., such as 100° C. to 120° C., such as 100° C. to 110° C., such as 110° C. to 130° C., such as 110° C. to 120° C., such as 120° C. to 130° C.

The second glass transition temperature may be at least −50° C., such as at least −40° C., such as at least −30° C., such as at least −20° C., such as at least −10° C., such as at least 0° C., such as at least 10° C., such as at least 20° C., such as at least 30° C., such as at least 40° C., such as at least 50° C., such as at least 60° C. The second glass transition temperature may be no more than 70° C., such as no more than 50° C., such as no more than 30° C., such as no more than 10° C., such as no more than 0° C., such as no more than −10° C., such as no more than −20° C., such as no more than −30° C. The second glass transition temperature may be from −50° C. to 70° C., such as −50° C. to 50° C., such as −50° C. to 30° C., such as −50° C. to 10° C., such as −50° C. to 0° C., such as −50° C. to −10° C., such as −50° C. to −20° C., such as −50° C. to −30° C., such as −40° C. to 70° C., such as −40° C. to 50° C., such as −40° C. to 30° C., such as −40° C. to 10° C., such as −40° C. to 0° C., such as −40° C. to −10° C., such as −40° C. to −20° C., such as −40° C. to −30° C., such as −30° C. to 70° C., such as −30° C. to 50° C., such as −30° C. to 30° C., such as −30° C. to 10° C., such as −30° C. to 0° C., such as −30° C. to −10° C., such as −30° C. to −20° C., such as −20° C. to 70° C., such as −20° C. to 50° C., such as −20° C. to 30° C., such as −20° C. to 10° C., such as −20° C. to 0° C., such as −20° C. to −10° C., such as −10° C. to 70° C., such as −10° C. to 50° C., such as −10° C. to 30° C., such as −10° C. to 10° C., such as −10° C. to 0° C., such as 0° C. to 70° C., such as 0° C. to 50° C., such as 0° C. to 30° C., such as 0° C. to 10° C., such as 10° C. to 70° C., such as 10° C. to 50° C., such as 10° C. to 30° C., such as 20° C. to 70° C., such as 20° C. to 50° C., such as 20° C. to 30° C., such as 30° C. to 70° C., such as 30° C. to 50° C., such as 40° C. to 70° C., such as 40° C. to 50° C., such as 50° C. to 70° C., such as 60° C. to 70° C.

The second resin domain may have a domain size of at least 50 nm, such as at least 100 nm, such as at least 150 nm, such as at least 200 nm, such as at least 250 nm, such as at least 300 nm, such as at least 350 nm, such as at least 400 nm, such as at least 450 nm, such as at least 500 nm, such as at least 550 nm, such as at least 600 nm, such as at least 650 nm, such as at least 700 nm, such as at least 750 nm, such as at least 800 nm. As used herein, the term “domain size” in reference to a resin domain refers to a measurement according to the following procedure: Coated and cured panels are cut down to size and embedded in EMBed-812 epoxy and cured at 60° C. for 24 hrs. Thin sections (<80 nm) are then ultra-microtomed and collected on Cu TEM grids. Brightfield images are taken on a Tecnai T20 TEM operating at 200 kV. The max Feret diameter of the low-density domains is determined by measuring 10 domains, in three different images, using ImageJ.

The electrodeposited coating optionally may further comprise a third glass transition temperature, and, if the third glass transition temperature is present, the third glass transition temperature may or may not correspond to the presence of a third resin domain. If present, the third glass transition temperature may be less than −50° C.

The glass transition temperature may be measured according to the procedure described in the examples section.

### Electrodepositable Binder

According to the present disclosure, the electrodepositable coating composition further comprises an electrodepositable binder. As used herein, an “electrodepositable binder” refers to any suitable inorganic or organic resinous material that may be applied used in an electrodepositable coating composition to enable the electrodepositable coating composition to be applied by the process of electrodeposition.

As used herein, the term “electrodepositable coating composition” refers to a composition that is capable of being deposited onto an electrically conductive substrate under the influence of an electrical potential applied between two electrodes immersed in the electrodepositable coating composition, where one of the electrodes is the substrate to be coated.

The electrodepositable coating composition comprises an electrodepositable binder that may comprise any suitable electrodepositable binder. For example, the electrodepositable binder may comprise an organic and/or inorganic electrodepositable binder. As used here-in the term “binder” refers to the non-volatile content, excluding fillers, of the electrodepositable coating composition.

As used herein, an “organic” electrodepositable binder may comprise a film-forming polymer and/or curing agent that comprises carbon-based materials. As used herein, an “inorganic” electrodepositable binder may comprise a film-forming polymer and/or curing agent that is based on other materials, such as, for example, silicone-based materials. It will be understood that the electrodepositable binder may also comprise a mixture of organic and inorganic film-former and/or curing agent materials.

As used herein, the term “film forming polymer” is used interchangeably with “polymer” or “resin”, and refers to one or more polymers, such as homopolymers and/or copolymers, as well as prepolymers, oligomers, and monomers, that are capable of forming a film upon reaction with a curing agent or crosslinker. As used herein, the term “crosslinker”, “crosslinking agent”, or “curing agent” refers to a molecule capable of forming a covalent linkage between polymers. For example, a polyisocyanate curing agent may react with active hydrogen groups on a film-forming polymer to effectuate at least partial cure of the coating composition to form a coating. As used herein, the term “cure”, “cured” or similar terms, means that at least a portion of the coating composition is crosslinked to form a coating.

The electrodepositable coating composition may comprise an ionic salt group-containing film-forming polymer, such as a cationic salt group containing film-forming polymer or an anionic salt group containing film-forming polymer.

For example, the ionic salt group-containing film-forming polymer may comprise a reaction product of a reaction mixture comprising (a) a polyepoxide; (b) di-functional chain extender; and (c) a mono-functional reactant. Non-limiting examples of such polymers are provided in Int'l App. No. PCT/US22/73356, at paragraphs [0023] to [0038], the cited portion of which is incorporated herein by reference.

As used herein, the term “cationic salt group-containing film-forming polymer” refers to polymers that include at least partially neutralized cationic salt groups, such as amine, sulfonium and/or ammonium salt groups, that impart a positive charge. The cationic salt group-containing film-forming polymer may comprise active hydrogen functional groups. As used herein, the term “active hydrogen functional groups” refers to those groups that are reactive with isocyanates, and include, for example, hydroxyl groups, primary or secondary amine groups, carbamate, and thiol groups.

Non-limiting examples of polymers that are suitable for use as the cationic salt group-containing film-forming polymer of the electrodepositable composition include, but are not limited to, alkyd polymers, acrylics, polyepoxides, polyamides, polyurethanes, polyureas, polyethers, and polyesters, as well as adducts, derivatives and combinations thereof.

The cationic salt group-containing film-forming polymer is made cationic and water dispersible by at least partial neutralization with an acid such as formic acid, acetic acid, methanesulfonic acid, lactic acid, phosphoric acid and/or sulfamic acid.

The extent of neutralization of the cationic salt group-containing film-forming polymer may vary with the particular polymer involved. However, sufficient acid should be used to sufficiently neutralize the cationic salt-group containing film-forming polymer such that the cationic salt-group containing film-forming polymer may be dispersed in an aqueous dispersing medium. For example, the amount of acid used may provide at least 20% of all of the total theoretical neutralization. Alternatively, the amount of acid used may provide in excess of 100% of all of the total theoretical neutralization. The total amount of acid used to neutralize the cationic salt group-containing film-forming polymer may range between any combination of values, for example, such as at 20% or more, to, such as greater than 100%, s inclusive of the recited values. For example, the total amount of acid used to neutralize the active hydrogen-containing, cationic salt group-containing film-forming polymer may be 20%, 35%, 50%, 60%, 80%, or 100% or greater, based on the total amines in the cationic salt group-containing film-forming polymer.

As used herein, the term “anionic salt group containing film-forming polymer” refers to an anionic polymer comprising at least partially neutralized anionic functional groups, such as carboxylic acid and/or phosphoric acid groups that impart a negative charge. The anionic salt group-containing film-forming polymer may comprise active hydrogen functional groups.

Non-limiting examples of polymers that are suitable for use as the anionic salt group-containing film-forming polymer of the electrodepositable binder include, but are not limited to, drying and/or semi-drying, and/or saturated alkyd polymers, acrylics, polyepoxides, polyamides, polyurethanes, polyureas, polyethers, polyesters, resinous polyols, phosphatized polyepoxides, and phosphatized acrylic polymers, vehicles comprising alkyds and amine-aldehydes, as well as adducts, derivatives and combinations thereof.

Non-limiting examples of inorganic electrodepositable film-forming polymers include silicone-based film-forming polymers. Non-limiting examples of such polymers are described in Int'l Pub. No. WO 2021/138384 At, at paragraphs [0007] through [0029], the cited portion of which is incorporated herein by reference.

The active hydrogen-containing, ionic salt group-containing film-forming polymer has an aromatic content of at least 10% by weight, based on the total weight of the active hydrogen-containing, ionic salt group-containing film-forming polymer, such as at least 15% by weight, such as at least 20% by weight, such as at least 25% by weight, such as at least 30% by weight, such as at least 35% by weight, such as at least 40% by weight.

As used herein, the term “aromatic content” refers to structures with pi bonds in resonance where the number of 1 electrons, according to molecular orbital theory, is equal to 4n+2, in which n=1, 2, 3, etc. A non-limiting example of a cyclic aromatic structure is a benzene ring having six π electrons and n=1. The weight percent of aromatic content in a polymer is determined by including only the atoms within the aromatic structure, e.g., for a benzene ring, only the six carbon atoms in the ring contribute to the aromatic content of the polymer.

The ionic salt group-containing film-forming polymer may be present in the electrodepositable coating composition in an amount of at least 40% by weight, such as at least 50% by weight, such as at least 55% by weight, such as at least 60% by weight, based on the total weight of the resin solids of the electrodepositable coating composition. The ionic salt group-containing film-forming polymer may be present in the electrodepositable coating composition in an amount of no more than 90% by weight, such as no more than 80% by weight, such as no more than 75% by weight, based on the total weight of the resin solids of the electrodepositable coating composition. The ionic salt group-containing film-forming polymer may be present in the electrodepositable coating composition, in an amount of 40% to 90% by weight, such as 40% to 80% by weight, such as 40% to 75% by weight, such as 50% to 90% by weight, such as 50% to 80% by weight, such as 50% to 75% by weight, such as 55% to 90% by weight, such as 55% to 80% by weight, such as 55% to 75% by weight, such as 60% to 90% by weight, such as 60% to 80% by weight, such as 60% to 75% by weight, based on the total weight of the resin solids of the electrodepositable coating composition.

As used herein, the “resin solids” include the ionic salt group-containing film-forming polymer, the curing agent, and any additional water-dispersible non-pigmented component(s) present in the electrodepositable coating composition.

The electrodepositable coating composition of the present disclosure may further comprise a curing agent. The curing agent may react with the reactive groups, such as active hydrogen groups, of the ionic salt group-containing film-forming polymer as well as any reactive groups, if present, of any additional resinous materials, to effectuate cure of the electrodepositable coating composition to form a coating. Non-limiting examples of suitable curing agents include at least partially blocked polyisocyanates, as well as aminoplast resins, and/or phenoplast resins, such as phenolformaldehyde condensates including allyl ether derivatives thereof.

As used herein, a “blocked polyisocyanate” means a polyisocyanate wherein at least a portion of the isocyanato groups is blocked by a blocking group introduced by the reaction of a free isocyanato group of the polyisocyanate with a blocking agent. By “blocked” is meant that the isocyanato groups have been reacted with a blocking agent such that the resultant blocked isocyanate group is stable to active hydrogens at ambient temperature, e.g., room temperature (23° C.). The reaction may be reversed under suitable conditions, such as at elevated temperatures, such as, e.g., between 90° C. and 200° C., such that the previously blocked isocyanato groups on the polyisocyanate curing agent are unblocked and available to react with the reactive groups, such as active hydrogen groups, of the ionic salt group-containing film-forming polymer to effectuate cure of the coating composition to form a coating.

As used herein, a “blocking agent” refers to a compound comprising a functional group reactive with an isocyanato group resulting in a blocked isocyanate. As used herein, a “blocking group” refers to the bound residual moiety of a blocking agent to the isocyanato group in the blocked polyisocyanate.

Blocking agents that are disassociated from the blocked polyisocyanate curing agent during cure may be removed from the coating film by volatilization. Alternatively, a portion or all of the blocking agent may remain in the coating film following cure.

Non-limiting examples of blocked polyisocyanates curing agents, and amounts thereof, including suitable polyisocyanates, and blocking components such as blocking groups and/or blocking agents, such as but not limited to 1,2 polyols, are provided in Int'l Pub. No. WO 2021/138583 A1, at paragraphs [0022] to [0035], the cited portion of which is incorporated herein by reference.

Non-limiting examples of blocked polyisocyanates comprising a blocking group derived from a blocking agent comprising an alpha-hydroxy amide, ester, or thioester and, optionally, a second blocking agent, are provided in Int'l Pub. No. WO 2018/148306 A1, at paragraphs [0010] to [0029], the cited portion of which is incorporated herein by reference. The blocked polyisocyanate may be a fully blocked polyisocyanate wherein essentially 100% of the isocyanato groups of the polyisocyanate are blocked with one or more blocking groups. Optionally, the blocked polyisocyanate curing agent may be an at least partially blocked polyisocyanate, having fewer than 100% of the isocyanato groups blocked, as long as the coating composition remains a stable dispersion, as defined herein.

The at least partially blocked polyisocyanate may be partially blocked with one or more of the blocking groups discussed above with the remaining isocyanato groups reacted with the polymer backbone, such as described in U.S. Pat. No. 3,947,338, at col. 2, line 65 through col. 5, line 33, the cited portion of which is herein incorporated by reference.

The blocked polyisocyanate curing agent may comprise a tris(alkoxycarbonylamino)-1,3,5-triazine (TACT). Non-limiting examples of suitable tris(alkoxycarbonylamino)-1,3,5-triazines include tris(methoxycarbonylamino)-, tris(butoxycarbonylamino)-, and tris(2-ethylhexoxycarbonylamino)-1,3,5-triazines, and any combination thereof.

The curing agent may comprise an aminoplast or a phenoplast resin. Aminoplast resins are condensation products of an aldehyde with an amino- or amido-group carrying substance. Phenoplast resins are formed by the condensation of an aldehyde and a phenol.

Non-limiting examples of commercially available aminoplast resins are those available under the trademark CYMEL® from Allnex Belgium SA/NV, such as CYMEL 1130 and 1156, and RESIMENE® from INEOS Melamines, such as RESIMENE 750 and 753. Examples of suitable aminoplast resins, and amounts thereof, also include those described in U.S. Pat. No. 3,937,679 at col. 16, line 3 to col. 17, line 47, this portion of which being hereby incorporated by reference. As is disclosed in the aforementioned portion of the '679 patent, the aminoplast may be used in combination with the methylol phenol ethers.

Suitable aminoplast and phenoplast resins also are described in U.S. Pat. No. 4,812,215 at col. 6, line 20 to col. 7, line 12, the cited portion of which being incorporated herein by reference.

Non-limiting examples of additional curing agents including silicone-based curing agents. Non-limiting examples of such curing agents are described in Int'l Pub. No. WO 2021/138384 A1, at paragraphs [0030] through [0043], the cited portion of which is incorporated herein by reference.

The curing agent may be present in the electrodepositable coating composition, in an amount of at least 10% by weight, such as at least 20% by weight, such as at least 25% by weight, based on the total weight of the resin solids of the electrodepositable coating composition. The curing agent may be present in the electrodepositable coating composition, in an amount of no more than 60% by weight, such as no more than 50% by weight, such as no more than 45% by weight, such as no more than 40% by weight, based on the total weight of the resin solids of the electrodepositable coating composition. The curing agent may be present in the electrodepositable coating composition, in an amount of 10% to 60% by weight, such as 10% to 50% by weight, such as 10% to 45% by weight, such as 10% to 40% by weight, such as 20% to 60% by weight, such as 20% to 50% by weight, such as 20% to 45% by weight, such as 20% to 40% by weight, such as 25% to 60% by weight, such as 25% to 50% by weight, such as 25% to 45% by weight, such as 25% to 40% by weight, based on the total weight of the resin solids of the electrodepositable coating composition.

According to the present disclosure, the electrodepositable coating and/or electrodepositable coating composition may optionally further comprise a curing catalyst. As used herein, the term “curing catalyst” is used interchangeably with “catalyst” and refers to materials that catalyze the curing reaction between components of the electrodepositable coating composition, such as, for example, the curing agent and film-forming polymers. For example, the catalyst may catalyze transurethanation reactions, and specifically catalyze the deblocking of blocked polyisocyanate blocking groups.

Non-limiting examples of curing catalysts include amine-containing compounds; compounds or complexes of metals such as bismuth, cerium, zinc, and/or titanium; and combinations thereof.

Catalysts suitable for cationic electrodepositable coating compositions include, without limitation, metal oxides (e.g., oxides of cerium, zirconium and bismuth) and salts thereof; zinc compounds or complexes; and/or a cyclic guanidine as described in U.S. Pat. No. 7,842,762 at col. 1, line 53 to col. 4, line 18 and col. 16, line 62 to col. 19, line 8, the cited portions of which being incorporated herein by reference.

Catalysts suitable for anionic electrodepositable coating compositions include, without limitation, latent acid catalysts. Latent acid catalysts are derivatives of acid catalysts that are generally activated by heating. Non-limiting examples of latent acid catalysts are identified in WO 2007/118024 at paragraph [0031]. Further examples of suitable latent acid catalysts include derivatives of acid catalysts such as sulfonic acids, such as derivatives of para-toluenesulfonic acid, such as pyridinium para-toluenesulfonate.

The amine-containing curing catalyst may comprise any suitable amine-containing curing catalyst, such as, but not limited to, curing catalysts comprising a guanidine, an imidazole, an amidine, and/or derivatives or combinations thereof.

Non-limiting examples of suitable guanidine curing catalysts are provided in Int'l Pub. No. WO 2018/0172519 A1, at paragraphs [0039] to [0050], the cited portion of which is incorporated herein by reference.

Non-limiting examples of imidazole curing catalysts are described in US Pub. No. 2022/0154014 A1, as paragraphs [0062] to [0108], the cited portion of which is incorporated herein by reference.

The amidine curing catalyst may, in a non-limiting example, comprise 1,8-diazabicyclo[5.4.0]undec-7-ene (DBU).

The zinc-containing catalyst may comprise a metal salt and/or complex of zinc such as, but not limited to, a zinc (II) amidine complex, zinc octoate, zinc naphthenate, zinc tallate, zinc carboxylates having from 8 to 14 carbons in the carboxylate group, zinc acetate, zinc sulfonates, zinc methanesulfonates, or any combination thereof. The zinc (II) amidine complex may contain amidine and carboxylate ligands.

The curing catalyst may be present in the electrodepositable coating composition in any suitable amount. For example, the amine and/or the zinc-containing curing catalyst may be present in the coating composition in an amount of at least 0.1% by weight, based on the total weight of the resin solids of the coating composition, such as at least 0.2% by weight, such as at least 0.5% by weight, such as at least 0.8% by weight, such as at least 1% by weight, such as at least 1.5% by weight. The amine and/or zinc-containing curing catalyst may be present in the coating composition in an amount of no more than 7% by weight, based on the total weight of the resin solids of the coating composition, such as no more than 4% by weight, such as no more than 2% by weight, such as no more than 1.5% by weight, such as no more than 1% by weight. The amine and/or zinc-containing curing catalyst may be present in the coating composition in an amount of 0.1% to 7% by weight, based on the total weight of the resin solids of the coating composition, such as 0.1% to 4% by weight, such as 0.1% to 2% by weight, such as 0.1% to 1.5% by weight, such as 0.1% to 1% by weight, such as 0.2% to 7% by weight, such as 0.2% to 4% by weight, such as 0.2% to 2% by weight, such as 0.2% to 1.5% by weight, such as 0.2% to 1% by weight, such as 0.5% to 7% by weight, such as 0.5% to 4% by weight, such as 0.5% to 2% by weight, such as 0.5% to 1.5% by weight, such as 0.5% to 1% by weight, such as 0.8% to 7% by weight, such as 0.8% to 4% by weight, such as 0.8% to 2% by weight, such as 0.8% to 1.5% by weight, such as 0.8% to 1% by weight, such as 1% to 7% by weight, such as 1% to 4% by weight, such as 1% to 2% by weight, such as 1% to 1.5% by weight, such as 1.5% to 7% by weight, such as 1.5% to 4% by weight, such as 1.5% to 2% by weight.

The curing catalyst may comprise a bismuth catalyst. Non-limiting examples of bismuth curing catalysts, and amounts thereof, are provided in Int'l Pub. No. WO 2021/138583 A1, at paragraphs [0036] to [0050], the cited portion of which is incorporated by reference.

The curing catalyst may comprise a titanium compound and/or complex such as, for example, Ti(OR¹)₄, wherein R¹ is an alkyl or aryl, such as wherein R¹ is a C3-C20 alkyl, such as wherein R¹ is n-butyl, such as tetrabutyl titanate.

The electrodepositable coating composition may be substantially free, essentially free, or completely free of catalytic tin. The electrodepositable coating composition may be substantially free, essentially free, or completely free of catalytic tin. As used herein, the electrodepositable coating composition is “substantially free” of catalytic tin if catalytic tin is present in an amount of less than 0.1% by weight, based on the total weight of the electrodepositable coating composition. As used herein, the electrodepositable coating composition is “essentially free” of catalytic tin if catalytic tin is present in an amount of less than 0.01%, based on the total weight of the electrodepositable coating composition. As used herein, the electrodepositable coating composition is “completely free” of catalytic tin if catalytic tin is present in an amount of 0.001%, based on the total weight of the electrodepositable coating composition.

### Organic Resinous Component

According to the present disclosure, the electrodeposited coating and/or electrodepositable coating compositions may further comprises at least one organic resinous component different than the primary components of the electrodepositable binder, such as, for example, the active hydrogen-containing, ionic salt group-containing film-forming polymer and curing agent.

As used herein, “organic resinous component” refers to an organic-based polymeric component.

The organic resinous component may have a weight average molecular weight of at least 1,000 g/mol or higher.

The organic resinous component may be present in an amount of at least 0.01% by weight, such as at least 0.1% by weight, such as at least 0.3% by weight, such as at least 0.5% by weight, such as at least 0.75% by weight, such as at least 1% by weight, such as at least 3% by weight, such as at least 5% by weight, such as at least 10% by weight, such as at least 15% by weight, such as at least 20% by weight, such as at least 25% by weight, based on the total weight of the electrodeposited coating and/or electrodepositable binder. The organic resinous component may be present in an amount of no more than 50% by weight, such as no more than 35% by weight, such as no more than 30% by weight, such as no more than 25% by weight, such as no more than 20% by weight, such as no more than 15% by weight, such as no more than 10% by weight, such as no more than 5% by weight, such as no more than 3% by weight, such as no more than 2% by weight, such as no more than 1.5% by weight, such as no more than 1% by weight, such as n no more than 0.75% by weight, based on the total weight of the electrodeposited coating and/or electrodepositable binder. The organic resinous component may be present in an amount of 0.01% to 50% by weight, such as 0.01% to 35% by weight, such as 0.01% to 30% by weight, such as 0.01% to 25% by weight, such as 0.01% to 20% by weight, such as 0.01% to 15% by weight, such as 0.01% to 10% by weight, such as 0.01% to 5% by weight, such as 0.01% to 3% by weight, such as 0.01% to 2% by weight, such as 0.01% to 1.5% by weight, such as 0.01% to 1% by weight, such as 0.01% to 0.75% by weight, such as 0.1% to 50% by weight, such as 0.1% to 35% by weight, such as 0.1% to 30% by weight, such as 0.1% to 25% by weight, such as 0.1% to 20% by weight, such as 0.1% to 15% by weight, such as 0.1% to 10% by weight, such as 0.1% to 5% by weight, such as 0.1% to 3% by weight, such as 0.1% to 2% by weight, such as 0.1% to 1.5% by weight, such as 0.1% to 1% by weight, such as 0.1% to 0.75% by weight, such as 0.3% to 35% by weight, such as 0.3% to 30% by weight, such as 0.3% to 25% by weight, such as 0.3% to 20% by weight, such as 0.3% to 15% by weight, such as 0.3% to 10% by weight, such as 0.3% to 5% by weight, such as 0.3% to 3% by weight, such as 0.3% to 2% by weight, such as 0.3% to 1.5% by weight, such as 0.3% to 1% by weight, such as 0.3% to 0.75% by weight, such as 0.5% to 50% by weight, such as 0.5% to 35% by weight, such as 0.5% to 30% by weight, such as 0.5% to 25% by weight, such as 0.5% to 20% by weight, such as 0.5% to 15% by weight, such as 0.5% to 10% by weight, such as 0.5% to 5% by weight, such as 0.5% to 3% by weight, such as 0.5% to 2% by weight, such as 0.5% to 1.5% by weight, such as 0.5% to 1% by weight, such as 0.5% to 0.75% by weight, such as 1% to 50% by weight, such as 1% to 35% by weight, such as 1% to 30% by weight, such as 1% to 25% by weight, such as 1% to 20% by weight, such as 1% to 15% by weight, such as 1% to 10% by weight, such as 1% to 5% by weight, such as 1% to 3% by weight, such as 1% to 2% by weight, such as 1% to 1.5% by weight, such as 3% to 50% by weight, such as 3% to 35% by weight, such as 3% to 30% by weight, such as 3% to 25% by weight, such as 3% to 20% by weight, such as 3% to 15% by weight, such as 3% to 10% by weight, such as 3% to 5% by weight, such as 5% to 50% by weight, such as 5% to 35% by weight, such as 5% to 30% by weight, such as 5% to 25% by weight, such as 5% to 20% by weight, such as 5% to 15% by weight, such as 5% to 10% by weight, such as 10% to 50% by weight, such as 10% to 35% by weight, such as 10% to 30% by weight, such as 10% to 25% by weight, such as 10% to 20% by weight, such as 10% to 15% by weight, such as 15% to 50% by weight, such as 15% to 35% by weight, such as 15% to 30% by weight, such as 15% to 25% by weight, such as 15% to 20% by weight, such as 20% to 50% by weight, such as 20% to 35% by weight, such as 20% to 30% by weight, such as 20% to 25% by weight, such as 25% to 50% by weight, such as 25% to 35% by weight, such as 25% to 30% by weight, based on the total weight of the electrodeposited coating and/or electrodepositable binder.

Non-limiting examples of suitable organic resinous components comprises (1) an addition polymer comprising a polymerization product of a polymeric dispersant and a second stage ethylenically unsaturated monomer composition comprising a second stage hydroxyl-functional (meth)acrylamide monomer and/or a second stage hydroxyl-functional (meth)acrylate monomer; (2) a hydroxyl-functional addition polymer comprising constitutional units, at least 70% of which comprise formula VIII:

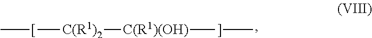

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group, and the % based upon the total constitutional units of the hydroxyl-functional addition polymer; (3) a cellulose derivative; (4) polyvinyl formamide; (5) a cationic epoxy microgel; (6) a polyamine-dialdehyde adduct; (7) a polyetheramine adduct; or any combination thereof.

As used herein, the term “addition polymer” refers to a polymerization product at least partially comprising the residue of unsaturated monomers.

Addition polymer comprising a polymerization product of a polymeric dispersant and a second stage ethylenically unsaturated monomer composition comprising a second stage hydroxyl-functional (meth)acrylamide monomer and/or a second stage hydroxyl-functional (meth)acrylate monomer: The organic resinous component may comprise an addition polymer comprising a polymerization product of a polymeric dispersant and a second stage ethylenically unsaturated monomer composition comprising a second stage hydroxyl-functional (meth)acrylamide monomer and/or a second stage hydroxyl-functional (meth)acrylate monomer.

According to the present disclosure, the electrodeposited coating and/or electrodepositable coating composition may comprise the addition polymer.

The addition polymer may comprise an acrylic polymer comprising a polymerization product of a polymeric dispersant and an aqueous dispersion of a second-stage ethylenically unsaturated monomer composition. As used herein, the term “acrylic polymer” refers to a polymerization product at least partially comprising the residue of (meth)acrylic monomers. The polymerization product may be formed by a two-stage polymerization process, wherein the polymeric dispersant is polymerized during the first stage and the second-stage ethylenically unsaturated monomer composition is added to an aqueous dispersion of the polymeric dispersant and polymerized in the presence of the polymeric dispersant that participates in the polymerization to form the acrylic polymer during the second stage. A non-limiting example of an acrylic polymer comprising a polymerization product of a polymeric dispersant and an aqueous dispersion of a second-stage ethylenically unsaturated monomer composition is described in Int'l Pub. No. WO 2018/160799 A1, at par. [0013] to [0055], the cited portion of which is incorporated herein by reference.

The addition polymer may alternatively comprise a polymerization product of a polymeric dispersant and a second stage ethylenically unsaturated monomer composition comprising a second stage (meth)acrylamide monomer.

According to the present disclosure, the polymeric dispersant may comprise any polymeric dispersant having a sufficient salt-group content to stably disperse and participate in a subsequent polymerization of a second-stage ethylenically unsaturated monomer composition and to provide for a resulting addition polymer that is stable in an electrodepositable coating composition. Although reference is made to the polymeric dispersant polymerized during the first stage, it will be understood that pre-formed or commercially available dispersants may be used, and the prior formation of the polymeric dispersant would be considered to be first stage polymerization.

According to the present disclosure, the polymeric dispersant polymerized during the first stage may comprise the polymerization product of a first-stage ethylenically unsaturated monomer composition.

The first-stage ethylenically unsaturated monomer composition comprises one or more monomers that allow for the incorporation of ionic salt-groups into the polymeric dispersant such that the polymeric dispersant comprises an ionic salt group-containing polymeric dispersant. For example, the polymeric dispersant may comprise cationic salt groups such that the polymeric dispersant comprises a cationic salt group-containing polymeric dispersant or anionic salt groups such that the polymeric dispersant comprises an anionic salt group-containing polymeric dispersant. The cationic salt groups may be formed by incorporation of an epoxide functional unsaturated monomer, an amino functional unsaturated monomer, or a combination thereof, and subsequent neutralization. For example, the polymeric dispersant may comprise a cationic salt group-containing polymeric dispersant comprising a polymerization product of a first stage ethylenically unsaturated monomer composition comprising an epoxide functional ethylenically unsaturated monomer, and/or an amino functional ethylenically unsaturated monomer. The anionic salt groups may be formed by incorporation of an acid functional unsaturated monomer and subsequent neutralization. For example, the polymeric dispersant may comprise an anionic salt group-containing polymeric dispersant comprising a polymerization product of a first stage ethylenically unsaturated monomer composition comprising an acid-functional ethylenically unsaturated monomer.

The first-stage ethylenically unsaturated monomer composition may optionally comprise an epoxide functional monomer. The epoxide functional monomer allows for the incorporation of epoxide functional groups into the polymeric dispersant. The epoxide functional groups may be converted to cationic salt groups via reaction of the epoxide functional group with an amine and neutralization with acid. Examples of suitable epoxide functional monomers include glycidyl acrylate, glycidyl methacrylate, 3,4-epoxycyclohexylmethyl(meth)acrylate, 2-(3,4-epoxycyclohexyl)ethyl(meth)acrylate, or allyl glycidyl ether. The epoxide functional monomer may be present in an amount of 5% to 50% by weight, such as 5% to 40% by weight, such as 5% to 30% by weight, such as 5% to 25% by weight, such as 5% to 20% by weight, such as 10% to 50% by weight, such as 10% to 40% by weight, such as 10% to 30% by weight, such as 10% to 25% by weight, such as 10% to 20% by weight, such as 20% to 50% by weight, such as 20% to 40% by weight, such as 20% to 30% by weight, such as 20% to 25% by weight, based on the total weight of the first-stage ethylenically unsaturated monomer composition.

The first-stage ethylenically unsaturated monomer composition may optionally comprise an amino functional monomer. The amino functional monomer allows for the incorporation of amino functional groups into the polymeric dispersant. The amino functional groups may be converted to cationic salt groups by neutralization with acid. The amino functional monomer may comprise any suitable amino functional unsaturated monomer, such as, for example, a N-alkylamino alkyl(meth)acrylate, a N,N-(dialkyl)amino alkyl(meth)acrylate, an amino alkyl(meth)acrylate, or the like. Specific non-limiting examples of suitable amino functional monomers include 2-aminoethyl (meth)acrylate, 2-(dimethylamino)ethylmethacrylate (“DMAEMA”), 2-(dimethylamino)ethyl acrylate, 3-(dimethylamino)propyl (meth)acrylate, 2-(diethylamino)ethyl (meth)acrylate, 2-(tert-butylamino)ethyl (meth)acrylate, and 2-(diethylamino)ethyl (meth)acrylate, as well as combinations thereof. The amino functional monomer may be present in an amount of 5% to 50% by weight, such as 5% to 40% by weight, such as 5% to 30% by weight, such as 5% to 25% by weight, such as 5% to 20% by weight, such as 10% to 50% by weight, such as 10% to 40% by weight, such as 10% to 30% by weight, such as 10% to 25% by weight, such as 10% to 20% by weight, such as 20% to 50% by weight, such as 20% to 40% by weight, such as 20% to 30% by weight, such as 20% to 25% by weight, based on the total weight of the first-stage ethylenically unsaturated monomer composition.

The first-stage ethylenically unsaturated monomer composition may optionally comprise an acid-functional ethylenically unsaturated monomer. The acid-functional monomer allows for the incorporation of anionic salt groups into the polymeric dispersant by neutralization with a base. The acid-functional ethylenically unsaturated monomer may comprise phosphoric acid or carboxylic acid functional ethylenically unsaturated monomers, such as, for example, (meth)acrylic acid. The acid functional monomer may be present in the first-stage ethylenically unsaturated monomer composition in an amount of 5% to 50% by weight, such as 5% to 40% by weight, such as 5% to 30% by weight, such as 5% to 25% by weight, such as 5% to 20% by weight, such as 10% to 50% by weight, such as 10% to 40% by weight, such as 10% to 30% by weight, such as 10% to 25% by weight, such as 10% to 20% by weight, such as 20% to 50% by weight, such as 20% to 40% by weight, such as 20% to 30% by weight, such as 20% to 25% by weight, based on the total weight of the first-stage ethylenically unsaturated monomer composition.

The first-stage ethylenically unsaturated monomer composition optionally may further comprise at least one of a C₁-C₁₈ alkyl (meth)acrylate; a first stage hydroxyl-functional (meth)acrylate; a vinyl aromatic compound; and/or a monomer comprising two or more ethylenically unsaturated groups per molecule.

The first-stage ethylenically unsaturated monomer composition optionally may further comprise monoolefinic aliphatic compounds such as C₁-C₁₈ alkyl (meth)acrylates. Examples of suitable C₁-C₁₈ alkyl (meth)acrylates include, without limitation, methyl (meth)acrylate, ethyl (meth)acrylate, butyl (meth)acrylate, hexyl (meth)acrylate, octyl (meth)acrylate, isodecyl (meth)acrylate, stearyl (meth)acrylate, 2-ethylhexyl (meth)acrylate, isobornyl (meth)acrylate, t-butyl (meth)acrylate, and the like. The C₁-C₁₈ alkyl (meth)acrylates may be present in the first-stage ethylenically unsaturated monomer composition in an amount of 30% to 90% by weight, such as 30% to 80% by weight, such as 30% to 70% by weight, such as 30% to 60% by weight, such as 40% to 90% by weight, such as 40% to 80% by weight, such as 40% to 70% by weight, such as 40% to 60% by weight, such as 50% to 90% by weight, such as 50% to 80% by weight, such as 50% to 70% by weight, such as 50% to 60% by weight, such as 60% to 90% by weight, such as 60% to 80% by weight, such as 60% to 70% by weight, such as 70% to 90% by weight, such as 70% to 80% by weight, based on the total weight of the first-stage ethylenically unsaturated monomer composition. As used herein, “(meth)acrylate” and like terms encompasses both acrylates and methacrylates.

The ethylenically unsaturated monomer composition optionally may comprise a hydroxyl-functional (meth)acrylate. As used herein the term “hydroxyl-functional (meth)acrylate” collectively refers both acrylates and methacrylates, which have hydroxyl functionality, i.e., comprise at least one hydroxyl functional group in the molecule. The hydroxyl-functional (meth)acrylate may comprise a hydroxyalkyl (meth)acrylate, such as, for example, hydroxymethyl (meth)acrylate, hydroxyethyl (meth)acrylate, hydroxypropyl (meth)acrylate, hydroxybutyl (meth)acrylate, hydroxypentyl (meth)acrylate, and the like, as well as combinations thereof. The hydroxyl-functional (meth)acrylate may be present in the first-stage ethylenically unsaturated monomer composition in an amount of 1% to 40% by weight, such as 1% to 30% by weight, such as 1% to 25% by weight, such as 1% to 15% by weight, such as 5% to 40% by weight, such as 5% to 30% by weight, such as 5% to 25% by weight, such as 5% to 15% by weight, such as 10% to 40% by weight, such as 10% to 30% by weight, such as 10% to 25% by weight, such as 10% to 15% by weight, based on the total weight of the first-stage ethylenically unsaturated monomer composition.

The first-stage ethylenically unsaturated monomer composition may comprise a vinyl aromatic compound. Non-limiting examples of suitable vinyl aromatic compounds include styrene, alpha-methyl styrene, alpha-chloromethyl styrene and/or vinyl toluene. The vinyl aromatic compound may be present in the first-stage ethylenically unsaturated monomer composition in an amount of 0.5% to 40% by weight, such as 0.5% to 30% by weight, such as 0.5% to 20% by weight, such as 0.5% to 15% by weight, such as 0.5% to 10% by weight, such as 1% to 40% by weight, such as 1% to 30% by weight, such as 1% to 20% by weight, such as 1% to 15% by weight, such as 1% to 10% by weight, such as 5% to 40% by weight, such as 5% to 30% by weight, such as 5% to 20% by weight, such as 5% to 15% by weight, such as 5% to 10% by weight, such as 10% to 40% by weight, such as 10% to 30% by weight, such as 10% to 20% by weight, such as 10% to 15% by weight, based on the total weight of the first-stage ethylenically unsaturated monomer composition.

The first-stage ethylenically unsaturated monomer composition optionally may comprise a monomer comprising two or more ethylenically unsaturated groups per molecule. The monomer comprising two or more ethylenically unsaturated groups per molecule may comprise a monomer having two ethylenically unsaturated groups per molecule. Examples of suitable monomers having two ethylenically unsaturated groups per molecule include ethylene glycol dimethacrylate, allyl methacrylate, hexanediol diacrylate, methacrylic anhydride, tetraethylene glycol diacrylate, and/or tripropylene glycol diacrylate. Examples of monomers having three or more ethylenically unsaturated groups per molecule include ethoxylated trimethylolpropane triacrylate having 0 to 20 ethoxy units, [ethoxylated]trimethylolpropane trimethacrylate having 0 to 20 ethoxy units, di-pentaerythritoltriacrylate, pentaerythritol tetraacrylate, and/or di-pentaerythritolpentaacrylate. The monomer comprising two or more ethylenically unsaturated groups per molecule may be present in the first-stage ethylenically unsaturated monomer composition in an amount of 0.1% to 10% by weight, such as 0.1% to 5% by weight, such as 0.1% to 3% by weight, such as 1% to 10% by weight, such as 1% to 5% by weight, such as 1% to 3% by weight, such as 3% to 10% by weight, such as 3% to 5% by weight, such as 5% to 10% by weight, based on the total weight of the first-stage ethylenically unsaturated monomer composition. The use of a monomer comprising two or more ethylenically unsaturated groups per molecule in the first-stage ethylenically unsaturated monomer composition may result in a polymeric dispersant comprising ethylenically unsaturated groups. Accordingly, the polymeric dispersant may comprise ethylenically unsaturated groups.

The first-stage ethylenically unsaturated monomer composition may comprise a first stage (meth)acrylamide monomer. As used herein, the term “first stage” with respect to a monomer, such as the (meth)acrylamide monomers, is intended to refer to a monomer used during the polymerization of the polymeric dispersant, and the resulting polymeric dispersant comprises the residue thereof. As used herein, the term “(meth)acrylamide” and like terms encompasses both acrylamides and methacrylamides. The first stage (meth)acrylamide monomers may comprise any suitable (meth)acrylamide monomer such as, for example, (meth)acrylamide, substituted or unsubstituted monoalkyl (meth)acrylamide monomers, or substituted or unsubstituted dialkyl (meth)acrylamide monomers. Non-limiting examples of the first stage (meth)acrylamide monomers include (meth)acrylamide, a C₁-C₁₈ alkyl (meth)acrylamide monomer, a hydroxyl-functional (meth)acrylamide monomer, and the like.

The first stage (meth)acrylamide monomers of the first-stage ethylenically unsaturated monomer composition optionally may comprise a C₁-C₁₈ alkyl (meth)acrylamide monomer. Examples of suitable C₁-C₁₈ alkyl (meth)acrylamide monomers include, without limitation, methyl (meth)acrylamide, ethyl (meth)acrylamide, butyl (meth)acrylamide, hexyl (meth)acrylamide, octyl (meth)acrylamide, isodecyl (meth)acrylamide, stearyl (meth)acrylamide, 2-ethylhexyl (meth)acrylamide, isobornyl (meth)acrylamide, t-butyl (meth)acrylamide, and the like. The C₁-C₁₈ alkyl (meth)acrylamide monomer may be present in the first-stage ethylenically unsaturated monomer composition in an amount of 30% to 90% by weight, such as 30% to 80% by weight, such as 30% to 70% by weight, such as 30% to 60% by weight, such as 40% to 90% by weight, such as 40% to 80% by weight, such as 40% to 70% by weight, such as 40% to 60% by weight, such as 50% to 90% by weight, such as 50% to 80% by weight, such as 50% to 70% by weight, such as 50% to 60% by weight, such as 60% to 90% by weight, such as 60% to 80% by weight, such as 60% to 70% by weight, such as 70% to 90% by weight, such as 70% to 80% by weight, based on the total weight of the first-stage ethylenically unsaturated monomer composition.

The ethylenically unsaturated monomer composition optionally may comprise a first stage hydroxyl-functional (meth)acrylamide monomer. As used herein the term “hydroxyl-functional (meth)acrylamide” collectively refers both acrylamides and methacrylamides, which have hydroxyl functionality, i.e., comprise at least one hydroxyl functional group in the molecule. The first stage hydroxyl-functional (meth)acrylamide monomer may comprise a hydroxyalkyl (meth)acrylamide, such as, for example, hydroxymethyl (meth)acrylamide, hydroxyethyl (meth)acrylamide, hydroxypropyl (meth)acrylamide, 2-hydroxypropyl (meth)acrylamide, hydroxybutyl (meth)acrylamide, hydroxypentyl (meth)acrylamide, and the like, as well as combinations thereof. The first stage hydroxyl-functional (meth)acrylamide monomer may be present in the first-stage ethylenically unsaturated monomer composition in an amount of 1% to 40% by weight, such as 1% to 30% by weight, such as 1% to 25% by weight, such as 1% to 15% by weight, such as 5% to 40% by weight, such as 5% to 30% by weight, such as 5% to 25% by weight, such as 5% to 15% by weight, such as 10% to 40% by weight, such as 10% to 30% by weight, such as 10% to 25% by weight, such as 10% to 15% by weight, based on the total weight of the first-stage ethylenically unsaturated monomer composition.

The polymeric dispersant may be prepared in organic solution by techniques well known in the art. For example, the polymeric dispersant may be prepared by conventional free radical initiated solution polymerization techniques wherein the first-stage ethylenically unsaturated monomer composition is dissolved in a solvent or a mixture of solvents and polymerized in the presence of a free radical initiator. Examples of suitable solvents which may be used for organic solution polymerization include alcohols, such as ethanol, tertiary butanol, and tertiary amyl alcohol; ketones, such as acetone, methyl ethyl ketone; and ethers, such as dimethyl ether of ethylene glycol. Examples of suitable free radical initiators include those which are soluble in the mixture of monomers, such as azobisisobutyronitrile, 2,2′-azobis(2-methylbutyronitrile), azobis-(alpha, gamma-dimethylvaleronitrile), tertiary-butyl perbenzoate, tertiary-butyl peracetate, benzoyl peroxide, and ditertiary-butyl peroxide. The free radical initiator may be present in an amount of 0.01% to 6% by weight, such as 1.0% to 4.0% by weight, such as 2.0% to 3.5% by weight, based on the total weight of the first-stage ethylenically unsaturated monomer composition. In examples, the solvent may be first heated to reflux and a mixture of the first-stage ethylenically unsaturated monomer composition and a free radical initiator may be added slowly to the refluxing solvent. The reaction mixture may be held at polymerizing temperatures so as to reduce the free monomer content to below 1.0%, such as below 0.5% by weight, based on the total weight of the first-stage ethylenically unsaturated monomer composition.

A chain transfer agent may be used in the synthesis of the polymeric dispersant, such as those that are soluble in the mixture of monomers. Suitable non-limiting examples of such agents include alkyl mercaptans, for example, tertiary-dodecyl mercaptan; ketones, such as methyl ethyl ketone; and chlorohydrocarbons, such as chloroform.

The polymeric dispersant may have a z-average molecular weight (M_{z}) of 200,000 g/mol to 2,000,000 g/mol, such as 200,000 g/mol to 1,200,000 g/mol, such as 200,000 g/mol to 900,000 g/mol, such as 250,000 g/mol to 2,000,000 g/mol, such as 250,000 g/mol to 1,200,000 g/mol, such as 250,000 g/mol to 900,000 g/mol, such as 300,000 to 2,000,000 g/mol, such as 300,000 g/mol to 1,200,000 g/mol, such as 300,000 g/mol to 900,000 g/mol.

According to the present disclosure, the polymeric dispersant may have a weight average molecular weight of 150,000 g/mol to 750,000 g/mol, such as 150,000 g/mol to 400,000 g/mol, such as 150,000 g/mol to 300,000 g/mol, such as 175,000 g/mol to 750,000 g/mol, such as 175,000 g/mol to 400,000 g/mol, such as 175,000 g/mol to 300,000 g/mol, such as 200,000 g/mol to 750,000 g/mol, such as 200,000 g/mol to 400,000 g/mol, such as 200,000 g/mol to 300,000 g/mol.

Ionic groups in the polymeric dispersant may be formed by at least partially neutralizing basic or acidic groups present in the polymeric dispersant with an acid or base, respectively. The ionic groups in the polymeric molecules may be charge neutralized by counter-ions. Ionic groups and charge neutralizing counter-ions may together form salt groups, such that the polymeric dispersant comprises an ionic salt group-containing polymeric dispersant.

Accordingly, the polymeric dispersant may be, prior to or during dispersion in a dispersing medium comprising water, at least partially neutralized by, for example, treating with an acid to form a water-dispersible cationic salt group-containing polymeric dispersant. As used herein, the term “cationic salt group-containing polymeric dispersant” refers to a cationic polymeric dispersant comprising at least partially neutralized cationic functional groups, such as sulfonium groups and ammonium groups, that impart a positive charge. The polymeric dispersant may be neutralized to the extent of at least 50%, such as at least 70% of the total theoretical neutralization equivalent. As used herein, the “total theoretical neutralization equivalent” refers to a percentage of the stoichiometric amount of acid to the total amount of basic groups, such as amino groups, theoretically present on the polymer. As discussed above, amines may be incorporated into the cationic polymeric dispersant by reaction of an amine with epoxide functional groups present in the polymeric dispersant. The step of dispersion may be accomplished by combining the neutralized or partially neutralized cationic salt group-containing polymeric dispersant with the dispersing medium of the dispersing phase. Neutralization and dispersion may also be accomplished in one step by combining the polymeric dispersant and the dispersing medium. The polymeric dispersant (or its salt) may be added to the dispersing medium or the dispersing medium may be added to the polymeric dispersant (or its salt). The pH of the dispersion may be within the range of 5 to 9.

The cationic salt group-containing polymeric dispersant may comprise a sufficient cationic salt group content to stabilize a subsequent polymerization of a second-stage ethylenically unsaturated monomer composition (described below) and to provide for a resulting addition polymer that is stable in a cationic electrodepositable coating composition. Also, the cationic salt group-containing polymeric dispersant may have sufficient cationic salt group content so that, when used with the other film-forming resins in the cationic electrodepositable coating composition, the composition upon being subjected to electrodeposition conditions will deposit as a coating on the substrate. The cationic salt group-containing polymeric dispersant may comprise, for example, 0.1 to 5.0, such as 0.3 to 1.1 milliequivalents of cationic salt groups per gram of cationic salt group-containing polymeric dispersant.

According to the present disclosure, the polymeric dispersant may be, prior to or during dispersion in a dispersing medium comprising water, at least partially neutralized by, for example, treating with a base to form a water-dispersible anionic salt group-containing polymeric dispersant. As used herein, the term “anionic salt group-containing polymeric dispersant” refers to an anionic polymeric dispersant comprising at least partially neutralized anionic functional groups, such as carboxylic acid and phosphoric acid groups, that impart a negative charge. Non-limiting examples of suitable bases are amines, such as, for example, tertiary amines. The polymeric dispersant may be neutralized to the extent of at least 50 percent or, in some cases, at least 70 percent, or, in other cases 100 percent or more, of the total theoretical neutralization equivalent. The step of dispersion may be accomplished by combining the neutralized or partially neutralized anionic salt group-containing polymeric dispersant with the dispersing medium of the dispersing phase. Neutralization and dispersion may be accomplished in one step by combining the polymeric dispersant and the dispersing medium. The polymeric dispersant (or its salt) may be added to the dispersing medium or the dispersing medium may be added to the polymeric dispersant (or its salt). The pH of the dispersion may be within the range of 5 to 9.

The anionic salt group-containing polymeric dispersant may comprise a sufficient anionic salt group content to stabilize a subsequent polymerization of a second-stage ethylenically unsaturated monomer composition (described below) and to provide for a resulting addition polymer that is stable in an anionic electrodepositable coating composition. Also, the anionic salt group-containing polymeric dispersant may have sufficient anionic salt group content so that, when used with the other film-forming resins in the anionic electrodepositable coating composition, the composition upon being subjected to anionic electrodeposition conditions will deposit as a coating on the substrate. The anionic salt group-containing polymeric dispersant may contain from 0.1 to 5.0, such as 0.3 to 1.1 milliequivalents of anionic salt groups per gram of anionic salt group-containing polymeric dispersant.

According to the present disclosure, the second-stage ethylenically unsaturated monomer composition comprises, consists essentially of, or consists of a monomer comprising three or more ethylenically unsaturated groups per molecule and at least one other monomer comprising a C₁-C₁₈ alkyl (meth)acrylate, a hydroxyl-functional (meth)acrylate, a vinyl aromatic compound, or any combination thereof. The second-stage ethylenically unsaturated monomer composition may be substantially free or, in some cases, completely free, of diene monomers. As used herein, when it is stated that the second-stage ethylenically unsaturated monomer composition is “substantially free” of diene monomers, it means that diene monomers are present in the monomer composition, if at all, in an amount of less than 10% by weight, such as less than 5% by weight, less than 2% by weight, or, in some cases, less than 1% or 0.1% by weight, based on the total weight of the second-stage ethylenically unsaturated monomer composition.

Non-limiting examples of monomers comprising three or more ethylenically unsaturated groups per molecule include, for example, trimethylolpropane triacrylate, pentaerythritol tetraacrylate, di-pentaerythritoltriacrylate, di-pentaerythritolpentaacrylate, ethoxylated trimethylolpropane triacrylate having 0 to 20 ethoxy units, and ethoxylated trimethylolpropane trimethacrylate having 0 to 20 ethoxy units. The ethylenically unsaturated monomer(s) having three or more sites of unsaturation are used in amounts of 0.1 to 10% by weight, such as 0.1 to 5% by weight, based on the total weight of the second-stage ethylenically unsaturated monomer composition.

The second-stage ethylenically unsaturated monomer composition may comprise the C₁-C₁₈ alkyl (meth)acrylate(s), if at all, in an amount of 20% to 80% by weight, such as 20% to 60% by weight, based on total weight of the second-stage ethylenically unsaturated monomer composition.

The second-stage ethylenically unsaturated monomer composition may comprise hydroxyl-functional (meth)acrylates, if at all, in an amount of 5% to 20% by weight, such as 5% to 15% by weight, based on total weight of the second-stage ethylenically unsaturated monomer composition.

The second-stage ethylenically unsaturated monomer composition may comprise vinyl aromatic compounds, if at all, in an amount of 20% to 80% by weight, such as 20% to 60% by weight, based on total weight of the second-stage ethylenically unsaturated monomer composition.

According to the present disclosure, the second-stage ethylenically unsaturated monomer composition comprises, consists essentially of, or consists of one or more second stage (meth)acrylamide monomers. As used herein, the term “second stage” with respect to a monomer, such as the (meth)acrylamide monomers, is intended to refer to a monomer used during the second polymerization step of the addition polymer that is polymerized in the presence of the pre-formed polymeric dispersant, and the resulting addition polymer comprises the residue thereof. The (meth)acrylamide monomers may comprise any suitable (meth)acrylamide monomer such as, for example, (meth)acrylamide, substituted or unsubstituted monoalkyl (meth)acrylamides, or substituted or unsubstituted dialkyl (meth)acrylamides. Non-limiting examples include (meth)acrylamide, a C₁-C₁₈ alkyl (meth)acrylamide, a hydroxyl-functional (meth)acrylamide, and the like.

The second-stage ethylenically unsaturated monomer composition may comprise, consist essentially of, or consist of (meth)acrylamide, such as (meth)acrylamide or acrylamide. The (meth)acrylamide monomer may be present in the second-stage ethylenically unsaturated monomer composition in an amount of 20% to 100% by weight, such as 20% to 99% by weight, such as 20% to 90% by weight, such as 20% to 80% by weight, such as 20% to 70% by weight, such as 20% to 60% by weight, such as 20% to 50% by weight, such as 30% to 100% by weight, such as 30% to 99% by weight, such as 30% to 90% by weight, such as 30% to 80% by weight, such as 30% to 70% by weight, such as 30% to 60% by weight, such as 30% to 50% by weight, such as 40% to 100% by weight, such as 40% to 99% by weight, such as 40% to 90% by weight, such as 40% to 80% by weight, such as 40% to 70% by weight, such as 40% to 60% by weight, such as 40% to 50% by weight, such as 50% to 100% by weight, such as 50% to 99% by weight, such as 50% to 90% by weight, such as 50% to 80% by weight, such as 50% to 70% by weight, such as 50% to 60% by weight, such as 60% to 100% by weight, such as 60% to 99% by weight, such as 60% to 90% by weight, such as 60% to 80% by weight, such as 60% to 70% by weight, such as 70% to 100% by weight, such as 70% to 99% by weight, such as 70% to 90% by weight, such as 70% to 80% by weight, such as 80% to 100% by weight, such as 80% to 99% by weight, such as 80% to 90% by weight, such as 90% to 100% by weight, such as 90% to 99% by weight, such as 95% to 100% by weight, such as 95% to 99% by weight, such as 95% to 100% by weight, such as 95% to 99% by weight, based on the total weight of the second-stage ethylenically unsaturated monomer composition.

The second-stage ethylenically unsaturated monomer composition may comprise, consist essentially of, or consist of a second-stage hydroxyl-functional (meth)acrylamide monomer. The second-stage hydroxyl-functional (meth)acrylamide monomer may comprise a primary hydroxyl group. The second-stage hydroxyl-functional (meth)acrylamide monomer may comprise a secondary hydroxyl group. The second-stage hydroxyl-functional (meth)acrylamide monomer may comprise one or more of a C₁-C₉ hydroxyalkyl (meth)acrylamide, such as a C₁-C₆ hydroxyalkyl (meth)acrylamide, such as a C₁-C₅ hydroxyalkyl (meth)acrylamide such as, for example, hydroxymethyl (meth)acrylamide, hydroxyethyl (meth)acrylamide, hydroxypropyl (meth)acrylamide, 2-hydroxypropyl (meth)acrylamide, hydroxybutyl (meth)acrylamide, hydroxypentyl (meth)acrylamide, or any combination thereof.

The second-stage hydroxyl-functional (meth)acrylamide monomer may be present in the second-stage ethylenically unsaturated monomer composition in an amount of 20% to 100% by weight, such as 20% to 99% by weight, such as 20% to 90% by weight, such as 20% to 80% by weight, such as 20% to 70% by weight, such as 20% to 60% by weight, such as 20% to 50% by weight, such as 30% to 100% by weight, such as 30% to 99% by weight, such as 30% to 90% by weight, such as 30% to 80% by weight, such as 30% to 70% by weight, such as 30% to 60% by weight, such as 30% to 50% by weight, such as 40% to 100% by weight, such as 40% to 99% by weight, such as 40% to 90% by weight, such as 40% to 80% by weight, such as 40% to 70% by weight, such as 40% to 60% by weight, such as 40% to 50% by weight, such as 50% to 100% by weight, such as 50% to 99% by weight, such as 50% to 90% by weight, such as 50% to 80% by weight, such as 50% to 70% by weight, such as 50% to 60% by weight, such as 60% to 100% by weight, such as 60% to 99% by weight, such as 60% to 90% by weight, such as 60% to 80% by weight, such as 60% to 70% by weight, such as 70% to 100% by weight, such as 70% to 99% by weight, such as 70% to 90% by weight, such as 70% to 80% by weight, such as 80% to 100% by weight, such as 80% to 99% by weight, such as 80% to 90% by weight, such as 90% to 100% by weight, such as 90% to 99% by weight, such as 95% to 100% by weight, such as 95% to 99% by weight, such as 95% to 100% by weight, such as 95% to 99% by weight, based on the total weight of the second-stage ethylenically unsaturated monomer composition.

The second-stage ethylenically unsaturated monomer composition may optionally comprise other ethylenically unsaturated monomers. The other ethylenically unsaturated monomers may comprise any ethylenically unsaturated monomers known in the art. Examples of other ethylenically unsaturated monomers that may be used in the second-stage ethylenically unsaturated monomer composition include, without limitation, the monomers described above with respect to the preparation of the polymeric dispersant, as well as di(meth)acrylates and poly(ethylene glycol) (meth)acrylates. Such monomers may be present, if at all, in an amount of 1% to 80% by weight, such as 1% to 70% by weight, such as 1% to 60% by weight, such as 1% to 50% by weight, such as 1% to 40% by weight, such as 1% to 30% by weight, such as 1% to 20% by weight, such as 1% to 10% by weight, such as 1% to 5% by weight, such as 5% to 80% by weight, such as 5% to 70% by weight, such as 5% to 60% by weight, such as 5% to 50% by weight, such as 5% to 40% by weight, such as 5% to 30% by weight, such as 5% to 20% by weight, such as 5% to 10% by weight, such as 10% to 80% by weight, such as 10% to 70% by weight, such as 10% to 60% by weight, such as 10% to 50% by weight, such as 10% to 40% by weight, such as 10% to 30% by weight, such as 10% to 20% by weight, such as 20% to 80% by weight, such as 20% to 70% by weight, such as 20% to 60% by weight, such as 20% to 50% by weight, such as 20% to 40% by weight, such as 20% to 30% by weight, such as 30% to 80% by weight, such as 30% to 70% by weight, such as 30% to 60% by weight, such as 30% to 50% by weight, such as 30% to 40% by weight, based on the total weight of the second-stage ethylenically unsaturated monomer composition.

The addition polymer may comprise a polymerization product comprising 10% to 90% by weight of the residue of the polymeric dispersant, such as 10% to 80% by weight, such as 10% to 70% by weight, such as 10% to 60% by weight, such as 10% to 50% by weight, such as 10% to 40% by weight, such as 10% to 30% by weight, such as 10% to 20% by weight, such as 20% to 90% by weight, such as 20% to 80% by weight, such as 20% to 70% by weight, such as 20% to 60% by weight, such as 20% to 50% by weight, such as 20% to 40% by weight, such as 20% to 30% by weight, such as 30% to 90% by weight, such as 30% to 80% by weight, such as 30% to 70% by weight, such as 30% to 60% by weight, such as 30% to 50% by weight, such as 30% to 40% by weight, such as 40% to 90% by weight, such as 40% to 80% by weight, such as 40% to 70% by weight, such as 40% to 60% by weight, such as 40% to 50% by weight, such as 50% to 90% by weight, such as 50% to 80% by weight, such as 50% to 70% by weight, such as 50% to 60% by weight, such as 60% to 90% by weight, such as 60% to 80% by weight, such as 60% to 70% by weight, such as 70% to 90% by weight, such as 70% to 80% by weight, such as 80% to 90% by weight, the percent by weight being based on the total weight of the addition polymer.

The addition polymer may comprise a polymerization product comprising 10% to 90% by weight of the residue of the second-stage ethylenically unsaturated monomer composition, such as 10% to 80% by weight, such as 10% to 70% by weight, such as 10% to 60% by weight, such as 10% to 50% by weight, such as 10% to 40% by weight, such as 10% to 30% by weight, such as 10% to 20% by weight, such as 20% to 90% by weight, such as 20% to 80% by weight, such as 20% to 70% by weight, such as 20% to 60% by weight, such as 20% to 50% by weight, such as 20% to 40% by weight, such as 20% to 30% by weight, such as 30% to 90% by weight, such as 30% to 80% by weight, such as 30% to 70% by weight, such as 30% to 60% by weight, such as 30% to 50% by weight, such as 30% to 40% by weight, such as 40% to 90% by weight, such as 40% to 80% by weight, such as 40% to 70% by weight, such as 40% to 60% by weight, such as 40% to 50% by weight, such as 50% to 90% by weight, such as 50% to 80% by weight, such as 50% to 70% by weight, such as 50% to 60% by weight, such as 60% to 90% by weight, such as 60% to 80% by weight, such as 60% to 70% by weight, such as 70% to 90% by weight, such as 70% to 80% by weight, such as 80% to 90% by weight, the percent by weight being based on the total weight of the addition polymer.

According to the present disclosure, the addition polymer may comprise a polymerization product of the polymeric dispersant and the second-stage ethylenically unsaturated monomer composition wherein the weight ratio of the second-stage ethylenically unsaturated monomer composition to the polymeric dispersant may be 9:1 to 1:9, such as 9:1 to 1:4, such as 9:1 to 3:7, such as 9:1 to 2:3, such as 9:1 to 1:1, such as 9:1 to 3:2, such as 9:1 to 7:3, such as 9:1 to 4:1, such as 4:1 to 1:9, such as 4:1 to 1:4, such as 4:1 to 3:7, such as 4:1 to 2:3, such as 4:1 to 1:1, such as 4:1 to 3:2, such as 4:1 to 7:3, such as 4:1 to 9:1, such as 7:3 to 1:9, such as 7:3 to 1:4, such as 7:3 to 3:7, such as 7:3 to 2:3, such as 7:3 to 1:1, such as 7:3 to 3:2, such as 7:3 to 4:1, such as 7:3 to 9:1, such as 3:2 to 1:9, such as 3:2 to 1:4, such as 3:2 to 3:7, such as 3:2 to 2:3, such as 3:2 to 1:1, such as 3:2 to 7:3, such as 3:2 to 4:1, such as 3:2 to 9:1, such as 1:1 to 1:9, such as 1:1 to 1:4, such as 1:1 to 3:7, such as 1:1 to 2:3, such as 1:1 to 3:2, such as 1:1 to 7:3, such as 1:1 to 4:1, such as 1:1 to 9:1, such as 2:3 to 1:9, such as 2:3 to 1:4, such as 2:3 to 3:7, such as 2:3 to 1:1, such as 2:3 to 3:2, such as 9:1 to 7:3, such as 2:3 to 4:1, such as 2:3 to 9:1, such as 3:7 to 1:9, such as 3:7 to 1:4, such as 3:7 to 2:3, such as 3:7 to 1:1, such as 3:7 to 3:2, such as 3:7 to 7:3, such as 3:7 to 4:1, such as 3:7 to 9:1, such as 1:4 to 1:9, such as 1.4 to 3:7, such as 1.4 to 2:3, such as 1.4 to 1:1, such as 1.4 to 3:2, such as 1.4 to 7:3, such as 1.4 to 4:1, such as 1:4 to 9:1, such as 1:9 to 1:4, such as 1:9 to 3:7, such as 1:9 to 2:3, such as 1:9 to 1:1, such as 1:9 to 3:2, such as 1:9 to 7:3, such as 1:9 to 4:1, such as 1:9 to 9:1.

The addition polymer may comprise active hydrogen functional groups. The active hydrogen functional groups may include hydroxyl groups, mercaptan groups, primary amine groups and/or secondary amine groups.

The addition polymer may have a theoretical hydroxyl equivalent weight of 120 g/OH to 310 g/OH, such as 130 g/OH to 275 g/OH, such as 140 g/OH to 200 g/OH, such as 145 g/OH to 160 g/OH.

The addition polymer may have a theoretical hydroxyl value of 190 to 400 mg KOH/gram addition polymer, such as 250 to 390 mg KOH/gram addition polymer, such as 320 to 380 mg KOH/gram addition polymer, such as 355 to 370 mg KOH/gram addition polymer. As used herein, the term “theoretical hydroxyl value” typically refers to the number of milligrams of potassium hydroxide required to neutralize the acetic acid taken up on acetylation of one gram of a chemical substance that contains free hydroxyl groups and was herein determined by a theoretical calculation of the number of free hydroxyl groups theoretically present in one gram of the addition polymer.

According to the present disclosure, the addition polymer may have a z-average molecular weight of 500,000 g/mol to 5,000,000 g/mol, such as 1,400,000 g/mol to 2,600,000 g/mol, such as 1,800,000 g/mol to 2,200,000 g/mol, such as 1,500,000 g/mol to 1,700,000 g/mol, such as 750,000 g/mol to 950,000 g/mol. The z-average molecular weight may be measured by gel permeation chromatography using polystyrene standards by the same procedure as described above.

According to the present disclosure, the addition polymer may have a weight average molecular weight of 200,000 g/mol to 1,600,000 g/mol, such as 400,000 g/mol to 900,000 g/mol, such as 500,000 g/mol to 800,000 g/mol. The weight average molecular weight may be measured by gel permeation chromatography using polystyrene standards by the same procedure as described above.

According to the present disclosure, the addition polymer may be substantially free, essentially free, or completely free of silicon. As used herein, “silicon” refers to elemental silicon or any silicon containing compound, such as an organosilicon compound including an alkoxysilane. As used herein, the addition polymer is “substantially free” of silicon if silicon is present in the addition polymer in an amount of less than 2% by weight, based on the total weight of the addition polymer. As used herein, the addition polymer is “essentially free” of silicon if silicon is present in the addition polymer in an amount of less than 1% by weight, based on the total weight of the addition polymer. As used herein, the addition polymer is “completely free” of silicon if silicon is not present in the addition polymer, i.e., 0% by weight.

According to the present disclosure, the addition polymer may be formed by a two-stage polymerization process. The first stage of the two-stage polymerization process comprises the formation of the polymeric dispersant from the first-stage ethylenically unsaturated monomer composition as described above. The second stage of the two-stage polymerization process comprises the formation of an addition polymer comprising a polymerization product of the polymeric dispersant formed during the first stage and a second-stage ethylenically unsaturated monomer composition as described above. The second-stage of the polymerization process may comprise (a) dispersing the second-stage ethylenically unsaturated monomer composition and a free radical initiator in a dispersing medium comprising water in the presence of the at least partially neutralized polymeric dispersant to form an aqueous dispersion, and (b) subjecting the aqueous dispersion to emulsion polymerization conditions, for example, by heating in the presence of the free radical initiator, to polymerize the components to form an aqueous dispersion comprising the formed addition polymer. The time and temperature of polymerization may depend on one another, the ingredients selected and, in some cases, the scale of the reaction. For example, the polymerization may be conducted at 40° C. to 100° C. for 2 to 20 hours.

The free radical initiator utilized for the polymerization of the polymeric dispersant and the second stage ethylenically unsaturated monomer composition may be selected from any of those used for aqueous addition polymerization techniques, including redox pair initiators, peroxides, hydroperoxides, peroxydicarbonates, azo compounds and the like. The free radical initiator may be present in an amount of 0.01% to 5% by weight, such as 0.05% to 2.0% by weight, such as 0.1% to 1.5% by weight, based on the weight of the second stage ethylenically unsaturated monomer composition. A chain transfer agent that is soluble in the monomer composition, such as alkyl mercaptans, for example, tertiary-dodecyl mercaptan, 2-mercaptoethanol, isooctyl mercaptopropionate, n-octyl mercaptan or 3-mercapto acetic acid may be used in the polymerization of the polymeric dispersant and the second stage ethylenically unsaturated monomer composition. Other chain transfer agents such as ketones, for example, methyl ethyl ketone, and chlorocarbons such as chloroform may be used. The amount of chain transfer agent, if present, may be 0.1% to 6.0% by weight, based on the weight of second stage ethylenically unsaturated monomer composition. Relatively high molecular weight multifunctional mercaptans may be substituted, all or partially, for the chain transfer agent. These molecules may, for example, range in molecular weight from about 94 to 1,000 g/mol or more. Functionality may be from about 2 to about 4. Amounts of these multifunctional mercaptans, if present, may be 0.1% to 6.0% by weight, based on the weight of the second stage ethylenically unsaturated monomer composition.

Water may be present in the aqueous dispersion in amounts of 40% to 90% by weight, such as 40% to 75% by weight, such as 40% to 60% by weight, such as 50% to 90% by weight, such as 50% to 75% by weight, such as 50% to 60% by weight, such as 60% to 90% by weight, such as 60% to 75% by weight, such as 75% to 90% by weight, based on total weight of the aqueous dispersion. The addition polymer may be added to the other components of the electrodepositable coating composition as an aqueous dispersion of the addition polymer.

In addition to water, the dispersing medium may further comprise organic cosolvents. The organic cosolvents may be at least partially soluble with water. Examples of such solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic cosolvents may be present in an amount of less than 10% by weight, such as less than 5% by weight, based on total weight of the dispersing medium.

The addition polymer may be present in the electrodepositable coating composition in an amount of 0.01% to 5% by weight, such as 0.01% to 3% by weight, such as 0.01% to 2% by weight, such as 0.01% to 1.5% by weight, such as 0.01% to 1% by weight, such as 0.01% to 0.75% by weight, such as 0.1% to 5% by weight, such as 0.1% to 3% by weight, such as 0.1% to 2% by weight, such as 0.1% to 1.5% by weight, such as 0.1% to 1% by weight, such as 0.1% to 0.75% by weight, such as 0.3% to 5% by weight, such as 0.3% to 3% by weight, such as 0.3% to 2% by weight, such as 0.3% to 1.5% by weight, such as 0.3% to 1% by weight, such as 0.3% to 0.75% by weight, such as 0.5% to 5% by weight, such as 0.5% to 3% by weight, such as 0.5% to 2% by weight, such as 0.5% to 1.5% by weight, such as 0.5% to 1% by weight, such as 0.5% to 0.75% by weight, such as 1% to 5% by weight, such as 1% to 3% by weight, such as 1% to 2% by weight, such as 1% to 1.5% by weight, based on the total weight of the resin solids of the electrodepositable coating composition.

Hydroxyl-functional addition polymer: As described above, the organic resinous component may comprise a hydroxyl-functional addition polymer comprising constitutional units, at least 70% of which comprise formula VIII:

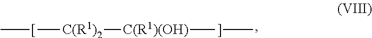

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group, and the % based upon the total constitutional units of the hydroxyl-functional addition polymer. Although the addition polymer described above may comprise hydroxyl functional groups, it is different than the hydroxyl-functional addition polymer.

Non-limiting examples of suitable alkyl radicals are methyl, ethyl, propyl, isopropyl, n-butyl, isobutyl, tert-butyl, amyl, hexyl, and 2-ethylhexyl.

Non-limiting examples of suitable cycloalkyl radicals are cyclobutyl, cyclopentyl, and cyclohexyl.

Non-limiting examples of suitable alkylcycloalkyl radicals are methylenecyclohexane, ethylenecyclohexane, and propane-1,3-diylcyclohexane.

Non-limiting examples of suitable cycloalkylalkyl radicals are 2-, 3- and 4-methyl-, -ethyl-, -propyl-, and -butylcyclohex-1-yl.

Non-limiting examples of suitable aryl radicals are phenyl, naphthyl, and biphenylyl.

Non-limiting examples of suitable alkylaryl radicals are benzyl-[sic], ethylene- and propane-1,3-diyl-benzene.

Non-limiting examples of suitable cycloalkylaryl radicals are 2-, 3-, and 4-phenylcyclohex-1-yl.

Non-limiting examples of suitable arylalkyl radicals are 2-, 3- and 4-methyl-, -ethyl-, -propyl-, and -butylphen-1-yl.

Non-limiting examples of suitable arylcycloalkyl radicals are 2-, 3-, and 4-cyclohexylphen-1-yl.

The above-described radicals R¹ may be substituted. Electron-withdrawing or electron-donating atoms or organic radicals may be used for this purpose.

Examples of suitable substituents are halogen atoms, such as chlorine or fluorine, nitrile groups, nitro groups, partly or fully halogenated, such as chlorinated and/or fluorinated, alkyl, cycloalkyl, alkylcycloalkyl, cycloalkylalkyl, aryl, alkylaryl, cycloalkylaryl, arylalkyl and arylcycloalkyl radicals, including those exemplified above, especially tert-butyl; aryloxy, alkyloxy and cycloalkyloxy radicals, especially phenoxy, naphthoxy, methoxy, ethoxy, propoxy, butyloxy or cyclohexyloxy; arylthio, alkylthio and cycloalkylthio radicals, especially phenylthio, naphthylthio, methylthio, ethylthio, propylthio, butylthio or cyclohexylthio; hydroxyl groups; and/or primary, secondary and/or tertiary amino groups, especially amino, N-methylamino, N-ethylamino, N-propylamino, N-phenylamino, N-cyclohexylamino, N,N-dimethylamino, N,N-diethylamino, N,N-dipropylamino, N,N-diphenylamino, N,N-dicyclohexylamino, N-cyclohexyl-N-methylamino or N-ethyl-N-methylamino.

R¹ may comprise, consist essentially of, or consist of hydrogen. For example, R¹ may comprise hydrogen in at least 80% of the constitutional units according to formula VIII, such as at least 90% of the constitutional units, such as at least 92% of the constitutional units, such as at least 95% of the constitutional units, such as 100% of the constitutional units.

The hydroxyl-functional addition polymer may comprise constitutional units according to formula VIII in an amount of at least 70%, such as at least 80%, such as at least 85%, such as at least 90%, the % based upon the total constitutional units of the hydroxyl-functional addition polymer. The hydroxyl-functional addition polymer may comprise constitutional units according to formula VIII in an amount of no more than 100%, such as no more than 95%, such as no more than 92%, such as no more than 90%, the % based upon the total constitutional units of the hydroxyl-functional addition polymer. The hydroxyl-functional addition polymer may comprise constitutional units according to formula VIII in an amount of 70% to 95% of the hydroxyl-functional addition polymer, such as 80% to 95%, such as such as 85% to 95%, such as 90% to 95%, such as 92% to 95%, such as 70% to 92%, such as 80% to 92%, such as such as 85% to 92%, such as 90% to 92%, such as 70% to 90%, such as 80% to 90%, such as such as 85% to 90%, the % based upon the total constitutional units of the hydroxyl-functional addition polymer.

According to the present disclosure, the hydroxyl-functional addition polymer may optionally further comprise constitutional units comprising the residue of a vinyl ester. The vinyl ester may comprise any suitable vinyl ester. For example, the vinyl ester may be according to the formula C(R¹)₂══C(R¹)(C(O)CH₃), wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group. Non-limiting examples of suitable vinyl esters include vinyl acetate, vinyl formate, or any combination thereof.

According to the present disclosure, the hydroxyl-functional addition polymer may be formed from polymerizing vinyl ester monomers to form an intermediate polymer comprising constitutional units comprising the residue of vinyl ester, and then hydrolyzing the constitutional units comprising the residue of vinyl ester of the intermediate polymer to form the hydroxyl-functional addition polymer. The residue of vinyl ester may comprise 70% to 95% of the hydroxyl-functional addition polymer, such as 80% to 95%, such as such as 85% to 95%, such as 90% to 95%, such as 92% to 95%, such as 70% to 92%, such as 80% to 92%, such as such as 85% to 92%, such as 90% to 92%, such as 70% to 90%, such as 80% to 90%, such as such as 85% to 90%, the % based upon the total constitutional units of the intermediate polymer.

According to the present disclosure, the hydroxyl-functional addition polymer may have a theoretical hydroxyl equivalent weight of 30 g/OH to 200 g/OH, such as 30 g/OH to 100 g/OH, such as 30 g/OH to 60 g/OH, such as 30 g/OH to 50 g/OH, such as 35 g/OH to 200 g/OH, such as 35 g/OH to 100 g/OH, such as 35 g/OH to 60 g/OH, such as 35 g/OH to 50 g/OH, such as 40 g/OH to 200 g/OH, such as 40 g/OH to 100 g/OH, such as 40 g/OH to 60 g/OH, such as 40 g/OH to 50 g/OH, such as 44 g/OH to 200 g/OH, such as 44 g/OH to 100 g/OH, such as 44 g/OH to 60 g/OH, such as 44 g/OH to 50 g/OH. As used herein, the term “theoretical hydroxyl equivalent weight” refers to the weight in grams of hydroxyl-functional addition polymer resin solids divided by the theoretical equivalents of hydroxyl groups present in the hydroxyl-functional addition polymer, and may be calculated according to the following formula (a):

$$hydroxyl equivalent weight = \frac{total grams addition polymer resin solds}{theoretical equivalents of OH} \qquad ( a )$$

According to the present disclosure, the hydroxyl-functional addition polymer may have a theoretical hydroxyl value of 1,000 to 1,300 mg KOH/gram addition polymer, such as 1,000 to 1,200 mg KOH/gram addition polymer, such as 1,000 to 1,150 mg KOH/gram addition polymer, such as 1,100 to 1,300 mg KOH/gram addition polymer, such as 1,100 to 1,200 mg KOH/gram addition polymer, such as 1,100 to 1,150 mg KOH/gram addition polymer, such as 1,150 to 1,300 mg KOH/gram addition polymer, such as 1,150 to 1,200 mg KOH/gram addition polymer.

According to the present disclosure, the hydroxyl-functional addition polymer may have a number average molecular weight (Mₙ) of 5,000 g/mol to 500,000 g/mol, such as 5,000 g/mol to 300,000 g/mol, such as 5,000 g/mol to 200,000 g/mol, such as 5,000 g/mol to 125,000 g/mol, such as 25,000 g/mol to 500,000 g/mol, such as 25,000 g/mol to 300,000 g/mol, such as 25,000 to 200,000 g/mol, such as 25,000 g/mol to 125,000 g/mol, such as 75,000 g/mol to 500,000 g/mol, such as 75,000 g/mol to 300,000 g/mol, such as 75,000 g/mol to 200,000 g/mol, such as 75,000 g/mol to 125,000 g/mol, such as 100,000 g/mol to 500,000 g/mol, such as 100,000 g/mol to 300,000 g/mol, such as 100,000 g/mol to 200,000 g/mol, such as 100,000 g/mol to 125,000 g/mol, as determined by Gel Permeation Chromatography using polystyrene calibration standards.

According to the present disclosure, the hydroxyl-functional addition polymer may have a weight average molecular weight of 5,000 g/mol to 500,000 g/mol, such as 5,000 g/mol to 300,000 g/mol, such as 5,000 g/mol to 200,000 g/mol, such as 5,000 g/mol to 125,000 g/mol, such as 25,000 g/mol to 500,000 g/mol, such as 25,000 g/mol to 300,000 g/mol, such as 25,000 to 200,000 g/mol, such as 25,000 g/mol to 125,000 g/mol, such as 75,000 g/mol to 500,000 g/mol, such as 75,000 g/mol to 300,000 g/mol, such as 75,000 g/mol to 200,000 g/mol, such as 75,000 g/mol to 125,000 g/mol, such as 100,000 g/mol to 500,000 g/mol, such as 100,000 g/mol to 300,000 g/mol, such as 100,000 g/mol to 200,000 g/mol, such as 100,000 g/mol to 125,000 g/mol, as determined by Gel Permeation Chromatography using polystyrene calibration standards.

As used herein, unless otherwise stated, the terms “number average molecular weight (Mₙ)” and “weight average molecular weight (M_{w})” mean the number average molecular weight (Mₙ) and the weight average molecular weight (M_{w}), respectively, as determined by Gel Permeation Chromatography using Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide (LiBr) as the eluent at a flow rate of 0.5 mL/min, and one Asahipak GF-510 HQ column for separation.

According to the present disclosure, a 4% by weight solution of the hydroxyl-functional addition polymer dissolved in water may have a viscosity of 10 to 110 cP as measured using a Brookfield synchronized-motor rotary type viscometer at 20° C., such as 10 to 90 cP, such as 10 to 70 cP, such as 10 to 50 cP, such as 10 to 40 cP, such as 15 to 110 cP, such as 15 to 90 cP, such as 15 to 70 cP, such as 15 to 60 cP, such as 15 to 50 cP, such as 15 to 40 cP, such as 20 to 110 cP, such as 20 to 90 cP, such as 20 to 70 cP, such as 20 to 60 cP, such as 20 to 50 cP, such as 20 to 40 cP.

According to the present disclosure, the hydroxyl-functional addition polymer described above may be present in the electrodepositable coating composition in an amount of at least 0.01% by weight, such as at least 0.1% by weight, such as at least 0.3% by weight, such as at least 0.5% by weight, such as at least 0.75% by weight, such as 1% by weight, based on the total weight of the resin solids of the electrodepositable coating composition. The hydroxyl-functional addition polymer described above may be present in the electrodepositable coating composition in an amount no more than 5% by weight, such as no more than 3% by weight, such as no more than 2% by weight, such as no more than 1.5% by weight, such as no more than 1% by weight, such as n no more than 0.75% by weight, based on the total weight of the resin solids of the electrodepositable coating composition. The hydroxyl-functional addition polymer may be present in the electrodepositable coating composition in an amount of 0.01% to 5% by weight, such as 0.01% to 3% by weight, such as 0.01% to 2% by weight, such as 0.01% to 1.5% by weight, such as 0.01% to 1% by weight, such as 0.01% to 0.75% by weight, such as 0.1% to 5% by weight, such as 0.1% to 3% by weight, such as 0.1% to 2% by weight, such as 0.1% to 1.5% by weight, such as 0.1% to 1% by weight, such as 0.1% to 0.75% by weight, such as 0.3% to 5% by weight, such as 0.3% to 3% by weight, such as 0.3% to 2% by weight, such as 0.3% to 1.5% by weight, such as 0.3% to 1% by weight, such as 0.3% to 0.75% by weight, such as 0.5% to 5% by weight, such as 0.5% to 3% by weight, such as 0.5% to 2% by weight, such as 0.5% to 1.5% by weight, such as 0.5% to 1% by weight, such as 0.5% to 0.75% by weight, such as 1% to 5% by weight, such as 1% to 3% by weight, such as 1% to 2% by weight, such as 1% to 1.5% by weight, based on the total weight of the resin solids of the electrodepositable coating composition.

Cellulose: As described above, the organic resinous component may comprise a water-soluble cellulose derivative. The water-soluble cellulose derivative may comprise hydroxyethyl cellulose, carboxymethyl cellulose, carboxymethylhydroxyethyl cellulose, hydroxymethyl cellulose, carboxyethyl cellulose, salts thereof, and combinations thereof. For example, the water-soluble cellulose derivative may comprise carboxymethylcellulose and salts thereof (CMC). CMC is a cellulosic ether in which a portion of the hydroxyl groups on the anhydroglucose rings are substituted with carboxymethyl groups. The degree of carboxymethyl substitution can range from 0.4-3. Since CMC is a long chain polymer, its viscosity in aqueous solutions depends on its molecular weight that can vary between 50,000 and 2,000,000 g/mol on a weight average basis. The carboxymethylcellulose may have a weight average molecular weight of at least 50,000, such as at least 100,000, such as at least 200,000, such as 50,000 to 1,000,000, 100,000 to 500,000, or 200,000 to 300,000 g/mol. Both the degree of substitution and the viscosity of aqueous solutions can be determined via ASTM D 1439-03. Molecular weight is typically estimated from the viscosity of standard CMC solutions.

The water-soluble cellulose derivative may be present in the electrodepositable coating composition in an amount of at least 0.001% by weight, such as at least 0.05% by weight, based on the total weight of the resin solids, such as 0.001% to 10% or 0.05% to 2%.

Polyvinyl formamide polymer: As described above, the organic resinous component may comprise a polyvinyl formamide polymer. The polyvinyl formamide polymer may be unhydrolyzed or partially or fully hydrolyzed. Hydrolysis of the formamide group provides a primary amine group; full hydrolysis of the polyvinyl formamide polymer provides a poly(vinyl amine). Hydrolyzed polyvinyl formamide polymers are commercially available from BASF under the trademark “LUAMIN®” with various weight average molecular weights (from about 340,000 dalton to less than 10,000 daltons) and various degrees of hydrolysis (10%, 30%, and 90%). The unhydrolyzed or hydrolyzed polyvinyl formamide polymer may also include monomer units other than vinyl amide and vinyl amine monomer units. In one embodiment of such a copolymer, vinyl formamide may be copolymerized with vinyl acetate; hydrolysis of the resulting copolymer may provide vinyl alcohol monomer units as well as vinyl amine monomer units. In one embodiment, the polyvinyl formamide polymer comprises only vinyl amide and vinyl amine monomer units (that is, the polyvinyl formamide polymer is a homopolymer of vinyl formamide or an at least partially hydrolyzed homopolymer of vinyl formamide).

The electrodeposition coating composition comprises the unhydrolyzed or hydrolyzed polyvinyl formamide polymer in an amount of generally less than one percent by weight of the coating composition. For example, the electrodeposition coating composition may comprise at least about 25 ppm by weight of the unhydrolyzed or hydrolyzed polyvinyl formamide polymer; in other examples, the aqueous electrodeposition coating composition may comprise at least about 50 ppm by weight of the unhydrolyzed or hydrolyzed polyvinyl formamide polymer. For example, the aqueous electrodeposition coating composition may comprise up to about 1000 ppm by weight of the unhydrolyzed or hydrolyzed polyvinyl formamide polymer; in other examples, the electrodeposition coating composition may comprise up to about 100 ppm by weight of the unhydrolyzed or hydrolyzed polyvinyl formamide polymer. Determining the optimum amount of the unhydrolyzed or hydrolyzed polyvinyl formamide polymer for a particular aqueous electrodeposition coating composition is straightforward, and, in general, satisfactory results may be achieved with amounts of the unhydrolyzed or hydrolyzed polyvinyl formamide polymer of less than 1000 ppm based on weight of the aqueous electrodeposition coating composition.

Cationic epoxy microgel: According to the present disclosure, the organic resinous component may comprise a cationic epoxy microgel. The cationic epoxy microgel refers to a cationic microgel dispersion that can be prepared by first dispersing in aqueous medium a reactive mixture of the cationic polyepoxide-amine reaction product and the polyepoxide crosslinking agent. The dispersion step can be accomplished by adding the polyepoxide-amine reaction product, preferably at elevated temperatures of from 100° C. to 150° C. to a mixture of water and acid to form a cationic dispersion of the resin in water. Typically, the solids content of the resulting dispersion will be about 20 to 50 percent by weight and the degree of neutralization will be from 20 to 100 percent of the total theoretical neutralization. The acid can be an organic acid such as formic acid, lactic acid and acetic acid as well as inorganic acid such as phosphoric acid and sulfamic acid. Also, blends of acids including blends of organic and inorganic acids can be used. The extent of neutralization depends upon the particular reaction product and usually only sufficient acid is added to stabilize the resulting microgel dispersion. The expression “cationic polyepoxide-amine reaction product which contains primary and/or secondary amine groups” includes primary and secondary amine groups and the acid salts thereof.

Polyamine-dialdehyde adduct: According to the present disclosure, the crater control additive may comprise a polyamine-dialdehyde adduct comprising, or in some cases consisting of, or in some cases consisting essentially of, a polymerization product of a polyamine and a dialdehyde. A polyamine and a dialdehyde may be polymerized to form the polymerization product. As used herein, “polyamine” includes compounds that include at least two amino groups, and the amino groups may comprise primary or secondary amino groups. As used herein, “primary amino groups” are derivatives of ammonia wherein one hydrogen atom has been replaced by an alkyl or aryl group and “secondary amino groups” are derivatives of ammonia wherein two hydrogen atoms have been replaced by alkyl or aryl groups. As used herein, “alkyl” refers to a hydrocarbon chain that may be linear or branched and may comprise one or more hydrocarbon rings that are not aromatic. As used herein, “aryl” refers to a hydrocarbon having a delocalized conjugated π-system with alternating double and single bonds between carbon atoms forming one or more coplanar hydrocarbon rings.

According to the present disclosure, the polyamine may comprise a cationic amine-functionalized resin, a polyetheramine, or combinations thereof. The cationic amine-functionalized resin may be derived from a polyepoxide. For example, the cationic amine-functionalized resin can be prepared by reacting together a polyepoxide and a polyhydroxyl group-containing material selected from alcoholic hydroxyl group-containing materials and phenolic hydroxyl group-containing materials to chain extend or build the molecular weight of the polyepoxide. Other hydroxyl-group containing materials that may comprise the cationic amine-functionalized resin include adducts of phenolic hydroxyl group-containing materials and alkylene oxides. The reaction product can then be reacted with a cationic salt group former to producing the cationic amine-functionalized resin.

According to the present disclosure, the polyamine also may comprise a polyetheramine which may be characterized by propylene oxide, ethylene oxide, or mixed propylene oxide and ethylene oxide repeating units in their respective structures, such as, for example, one of the Jeffamine series products (commercially available from Huntsman Corporation). Examples of such polyetheramines include aminated propoxylated pentaerythritols, such as Jeffamine XTJ-616, and those represented by Formulas (IX) through (XI).

According to Formula (IX) of the present disclosure the polyetheramine may comprise or represent:

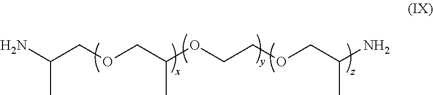

wherein y=0-39, x+z=1-68.

Suitable polyetheramines represented by Formula (IX) include, but are not limited to, amine-terminated polyethylene glycol such as Huntsman Corporation Jeffamine ED series, such as Jeffamine HK-511, Jeffamine ED-600, Jeffamine ED-900 and Jeffamine ED-2003, and amine-terminated polypropylene glycol such as Huntsman Corporation Jeffamine D series, such as Jeffamine D-230, Jeffamine D-400, Jeffamine D-2000 and Jeffamine D-4000.

According to Formula (X) of the present disclosure the polyetheramine may comprise or represent:

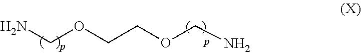

wherein each p independently is 2 or 3.

Suitable polyetheramines represented by Formula (X) include, but are not limited to, amine-terminated polyethylene glycol-based diamine, such as Huntsman Corporation Jeffamine EDR series, such as Jeffamine EDR-148 and Jeffamine EDR-176.

According to Formula (XI) of the present disclosure the polyetheramine may comprise or represent:

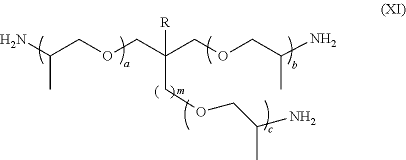

wherein R is H or C₂H₅, m=0 or 1, a+b+c=5-85.

Suitable polyetheramines represented by Formula (XI) include, but are not limited to, amine-terminated propoxylated trimethylolpropane or glycerol, such as Huntsman Corporation Jeffamine T series, such as Jeffamine T-403, Jeffamine T-3000 and Jeffamine T-5000.

The z-average molecular weight (M_{z}) of the polyamine may be 5,000 g/mol to 300,000 g/mol, such as 7,000 g/mol to 100,000 g/mol, such as 10,000 g/mol to 15,000 g/mol. As used herein, the term “z-average molecular weight (M_{z})” means the z-average molecular weight (M_{z}) as determined by Gel Permeation Chromatography using Waters 2695 separation module with a Waters 410 differential refractometer (RI detector), polystyrene standards having molecular weights of from approximately 500 g/mol to 900,000 g/mol, dimethylformamide (DMF) with lithium bromide (LiBr) as the eluent at a flow rate of 0.5 mL/min, and one Asahipak GF-510 HQ column for separation.

The amine equivalent weight of the polyamine may be from 200 g/amine to 5,000 g/amine, such as 400 g/amine to 2,000 g/amine, such as 450 g/amine to 600 g/amine. As used herein, the “amine equivalent weight” is determined by dividing the molecular weight of the amine-containing compound by the number of amino groups present in the polyamine.

As described above, according to the present disclosure, the polyamine may be polymerized with a dialdehyde to form the polyamine-dialdehyde adduct. The dialdehyde may comprise two aldehyde functional groups per molecule. As used herein, an “aldehyde functional group” comprises the structure R—CHO, wherein the carbon atom of a carbonyl is bonded to a hydrogen atom and an alkyl group represented by the letter R. Suitable dialdehyde compounds include, but are not limited to, glyoxal, glutaraldehyde and combinations thereof.

According to the present disclosure, the polymerization of the polyamine with the dialdehyde to form the polyamine-dialdehyde adduct may be performed in an aqueous medium at a pH of less than 7, such as less than 6.5, and may be at a pH of at least 2, such as at least 5. According to the present disclosure, the polymerization of the polyamine with the dialdehyde to form the polyamine-dialdehyde adduct may be performed in an aqueous medium at a pH of 2 to 7, such as 5 to 6.5.

According to the present disclosure, the polyamine-dialdehyde adduct may have a z-average molecular weight (Mz) of 100,000 g/mol to 1,000,000 g/mol, such as 300,000 g/mol to 700,000 g/mol, such as 400,000 g/mol to 600,000 g/mol. One of skill in the art recognizes that there are inherent limitations on the measurement of molecular weight for high molecular weight compounds, such as compounds having a molecular weight over 900,000 g/mol. Accordingly, although the theoretical z-average molecular weight (M_{z}) of the polyamine-dialdehyde adduct is expected to increase as the ratio of dialdehyde to polyamine approaches 1 (i.e., the ratio of dialdehyde to polyamine is <1), the measured molecular weight may not reflect that due to limitations in the measurement standards. This result is expected, not because the adduct does not have an increased molecular weight at the higher stoichiometric ratio, but because it is difficult to measure the molecular weight of such high molecular weight compounds according to the present analytical methods. Specifically, as GPC is a method of size exclusion chromatography, higher molecular weight polymers elute from the column more quickly than lower molecular weight polymers. Once the majority of the polymers exceed a certain molecular weight, the polymer molecules elute too quickly from the column to determine an accurate molecular weight.

As discussed in more detail below, the polyamine-dialdehyde adduct may function in the electrodepositable coating composition as either the main vehicle, as an additive that is added to the electrodepositable coating composition as a pre-blended component of the resin blend, or as a combination of main vehicle and additive.

As described above, according to the present disclosure, the polyamine-dialdehyde adduct may function in the electrodepositable coating composition as the main vehicle. In such instances, the polyamine-dialdehyde adduct may be present in the electrodepositable coating composition in an amount of 50% to 95% by weight based on the total amount of resin blend solids, such as 70% to 90%, such as 75% to 85%.

According to the present disclosure, the polyamine-dialdehyde adduct may function as the main vehicle. According to the present disclosure, the stoichiometric ratio of aldehyde functional groups of the dialdehyde compound to primary and/or second amino functional groups from the polyamine may be 2:1 to 20:1, such as 3:1 to 15:1, such as 4:1 to 14:1.

According to the present disclosure, the polyamine-dialdehyde adduct also may function in the electrodepositable coating composition as an additive. In such instances, according to the present disclosure, the polyamine-dialdehyde adduct may be present in the electrodepositable coating composition in an amount of 0.2% to 20% by weight based on the total amount of resin blend solids, such as 0.5% to 15%, such as 0.75% to 10%, such as 1% to 4%.

According to the present disclosure, the polyamine-dialdehyde adduct may function as an additive. In such instances, the stoichiometric ratio of aldehyde functional groups from the dialdehyde compound to primary and/or secondary amino functional groups from the polyamine may be 2:10 to 1:1, such as 3:10 to 9:10, such as 5:10 to 8:10, such as 5:10 to 7:10. As the stoichiometric ratio of aldehyde functional groups to amino functional groups increases, the molecular weight of the resulting polyamine-dialdehyde adduct correspondingly increases assuming a constant number of amino groups per polyamine molecule.

Polyetheramine Adduct: According to the present disclosure, the electrodepositable coating composition may further comprise a polyetheramine-adduct comprising an ungelled ionic reaction product prepared from reactants comprising: (a) an epoxy functional material or a reaction product prepared from reactants comprising: (1) a polyol; and (2) an epoxy functional material; and (b) a polyetheramine.

Examples of suitable epoxy-functional materials useful for forming the ungelled ionic reaction product contain at least one epoxy group in the molecule, such as di- or polyglycidyl ethers of polyhydric alcohols, such as a polyglycidyl ether of bisphenol A. Suitable epoxy-functional materials may have an epoxy equivalent weight ranging from about 90 to about 2000, as measured by titration with perchloric acid using methyl violet as an indicator. The epoxy-functional material may comprise about 10% to 40% by weight based on the total weight of the epoxy functional polyester, such as 15% to 35% by weight of the epoxy functional material is combined or reacted with the polyester described above to form the epoxy functional polyester.

Examples of suitable polyols useful for forming the ungelled ionic reaction product include resorcinol, dihydroxy benzene, aliphatic, cycloaliphatic or aralaphatic hydroxyl containing compounds, such as ethylene glycol, propylene glycol, bisphenol A, dihydroxyl cyclohexane, dimethylol cyclohexane, or combinations thereof. The polyol may be present in the polyetheramine adduct in an amount of about 0% to 20% by weight based on the total weight of the reactants that form the polyether reaction product, such as 0% to 15% by weight.

According to the present disclosure, the polyetheramine adduct may be formed by reacting the ungelled ionic reaction product with at least one polyetheramine which may be the same as those described above characterized by propylene oxide, ethylene oxide, or mixed propylene oxide and ethylene oxide repeating units in their respective structures, such as, for example, one of the Jeffamine series products (commercially available from Huntsman Corporation). Examples of such polyetheramines include aminated propoxylated pentaerythritols, such as Jeffamine XTJ-616, and those represented by Formulas (IX) through (XI) above.

Further examples of the polyetheramine-adduct are those described in U.S. Pat. Nos. 4,420,574, and 4,423,166, which are incorporated herein by reference.

The polyetheramine adduct may have a polyalkylene oxide content, such as a polyethylene oxide, polypropylene oxide, polybutylene oxide, etc. content, of at least 50% by weight, based on the total weight of the polyetheramine adduct, such as at least 60% by weight, such as at least 70% by weight, such as at least 80% by weight, such as at least 90% by weight.

The polyetheramine adduct may have a weight average molecular weight of at least 1,000 g/mol, such as at least 3,000 g/mol, such as at least 10,000 g/mol, such as at least 30,000 g/mol, such as at least 50,000 g/mol, such as at least 75,000 g/mol, such as such as at least 100,000 g/mol, such as at least 125,000 g/mol. The polyetheramine adduct may have a weight average molecular weight of no more than 500,000 g/mol, such as no more than 400,000 g/mol, such as no more than 300,000 g/mol, such as no more than 250,000 g/mol, such as no more than 200,000 g/mol, such as no more than 150,000 g/mol, such as no more than 100,000 g/mol, such as no more than 50,000 g/mol, such as no more than 25,000 g/mol, such as no more than 10,000 g/mol, such as no more than 8,000 g/mol. The polyetheramine adduct may have a weight average molecular weight of 1,000 to 500,000 g/mol, such as 1,000 to 400,000 g/mol, such as 1,000 to 300,000 g/mol, such as 1,000 to 250,000 g/mol, such as 1,000 to 200,000 g/mol, such as 1,000 to 150,000 g/mol, such as 1,000 to 100,000 g/mol, such as 1,000 to 50,000 g/mol, such as 1,000 to 25,000 g/mol, such as 1,000 to 10,000 g/mol, such as 1,000 to 8,000 g/mol, such as 3,000 to 500,000 g/mol, such as 3,000 to 400,000 g/mol, such as 3,000 to 300,000 g/mol, such as 3,000 to 250,000 g/mol, such as 3,000 to 200,000 g/mol, such as 3,000 to 150,000 g/mol, such as 3,000 to 100,000 g/mol, such as 3,000 to 50,000 g/mol, such as 3,000 to 25,000 g/mol, such as 3,000 to 10,000 g/mol, such as 3,000 to 8,000 g/mol, such as 10,000 to 500,000 g/mol, such as 10,000 to 400,000 g/mol, such as 10,000 to 300,000 g/mol, such as 10,000 to 250,000 g/mol, such as 10,000 to 200,000 g/mol, such as 10,000 to 150,000 g/mol, such as 10,000 to 100,000 g/mol, such as 10,000 to 50,000 g/mol, such as 10,000 to 25,000 g/mol, such as 30,000 to 500,000 g/mol, such as 30,000 to 400,000 g/mol, such as 30,000 to 300,000 g/mol, such as 30,000 to 250,000 g/mol, such as 30,000 to 200,000 g/mol, such as 30,000 to 150,000 g/mol, such as 30,000 to 100,000 g/mol, such as 30,000 to 50,000 g/mol, such as 50,000 to 500,000 g/mol, such as 50,000 to 400,000 g/mol, such as 50,000 to 300,000 g/mol, such as 50,000 to 250,000 g/mol, such as 50,000 to 200,000 g/mol, such as 50,000 to 150,000 g/mol, such as 50,000 to 100,000 g/mol, such as 75,000 to 500,000 g/mol, such as 75,000 to 400,000 g/mol, such as 75,000 to 300,000 g/mol, such as 75,000 to 250,000 g/mol, such as 75,000 to 200,000 g/mol, such as 75,000 to 150,000 g/mol, such as 75,000 to 100,000 g/mol, such as 100,000 to 500,000 g/mol, such as 100,000 to 400,000 g/mol, such as 100,000 to 300,000 g/mol, such as 100,000 to 250,000 g/mol, such as 100,000 to 200,000 g/mol, such as 100,000 to 150,000 g/mol, such as 125,000 to 500,000 g/mol, such as 125,000 to 400,000 g/mol, such as 125,000 to 300,000 g/mol, such as 125,000 to 250,000 g/mol, such as 125,000 to 200,000 g/mol, such as 125,000 to 150,000 g/mol.

The polyetheramine-adduct may be present in the electrodeposited coating and/or electrodepositable coating composition in an amount of at least 3% by weight based on the total weight of the electrodepositable binder, such as at least 5% by weight, such as at least 10% by weight, such as at least 15% by weight, such as at least 20% by weight, such as at least 25% by weight. The polyetheramine-adduct may be present in the electrodeposited coating and/or electrodepositable coating composition in an amount of no more than 35% by weight, such as no more than 30% by weight based on the total weight of the electrodepositable binder, such as no more than 25% by weight, such as no more than 20% by weight, such as no more than 15% by weight, such as no more than 10% by weight, such as no more than 5% by weight. The polyetheramine-adduct may be present in the electrodeposited coating and/or electrodepositable coating composition in an amount of 3% to 35% by weight, such as 3% to 30% by weight, such as 3% to 25% by weight, such as 3% to 20% by weight, such as 3% to 15% by weight, such as 3% to 10% by weight, such as 3% to 5% by weight, such as 5% to 35% by weight, such as 5% to 30% by weight, such as 5% to 25% by weight, such as 5% to 20% by weight, such as 5% to 15% by weight, such as 5% to 10% by weight, such as 10% to 35% by weight, such as 10% to 30% by weight, such as 10% to 25% by weight, such as 10% to 20% by weight, such as 10% to 15% by weight, such as 15% to 35% by weight, such as 15% to 30% by weight, such as 15% to 25% by weight, such as 15% to 20% by weight, such as 20% to 35% by weight, such as 20% to 30% by weight, such as 20% to 25% by weight, such as 25% to 35% by weight, such as 25% to 30% by weight, based on the total weight of the electrodepositable binder.

### Further Components of the Electrodeposited Coating and/or Electrodepositable Coating Composition

The electrodeposited coating and/or electrodepositable coating composition may optionally comprise one or more further components in addition to those described above.

The electrodeposited coating and/or electrodepositable compositions may optionally comprise a corrosion inhibitor. Any suitable corrosion inhibitor may be used. For example, the corrosion inhibitor may comprise a corrosion inhibitor comprising yttrium, lanthanum, cerium, calcium, an azole, or any combination thereof.

Non-limiting examples of suitable azoles include benzotriazole, 5-methyl benzotriazole, 2-amino thiazole, as well as salts thereof.

The corrosion inhibitor(s) may be present, if at all, in the electrodeposited coating and/or electrodepositable coating composition in an amount of at least 0.001% by weight, such as at least 5% by weight, based on the total weight of the electrodeposited coating and/or total solids weight of the electrodepositable coating composition. The corrosion inhibitor(s) may be present, if at all, in the electrodepositable coating composition in an amount of no more than 25% by weight, such as no more than 15% by weight, such as no more than 10% by weight, based on the total weight of the electrodeposited coating and/or total solids weight of the electrodepositable coating composition. The corrosion inhibitor(s) may be present, if at all, in the electrodepositable coating composition in an amount of 0.001% to 25% by weight, such as 0.001% to 15% by weight, such as 0.001% to 10% by weight, such as 5% to 25% by weight, such as 5% to 15% by weight, such as 5% to 10% by weight, based on the total weight of the electrodeposited coating and/or total solids weight of the electrodepositable coating composition.

Alternatively, the electrodeposited coating and/or electrodepositable coating composition may be substantially free, essentially free, or completely free of a corrosion inhibitor.

According to the present disclosure, the electrodeposited coating and/or electrodepositable coating composition may comprise other optional ingredients, such as if desired, various additives such as fillers, plasticizers, antioxidants, biocides, UV light absorbers and stabilizers, hindered amine light stabilizers, defoamers, fungicides, dispersing aids, flow control agents, surfactants, wetting agents, or combinations thereof. Alternatively, the electrodeposited coating and/or electrodepositable coating composition may be completely free of any of the optional ingredients, i.e., the optional ingredient is not present in the electrodeposited coating and/or electrodepositable coating composition. The other additives mentioned above may be present in the electrodeposited coating and/or electrodepositable coating composition in amounts of 0.01% to 3% by weight, based on total weight of the resin solids of the electrodeposited coating and/or electrodepositable coating composition.

The electrodeposited coating and/or electrodepositable coating composition optionally may further comprise a fire-retardant pigment. As used herein, “fire-retardant pigment” refers to a pigment that contributes to the fire-retardancy of a coating.

The fire-retardant pigment may comprise an inorganic pigment, a mineral, or a combination thereof.

As used herein, the term “inorganic” refers to materials that do not include carbon atoms.

Non-limiting examples of inorganic pigments or minerals include a metal hydroxide, such as aluminum hydroxide, aluminum oxide or a hydrate thereof, magnesium hydroxide, a zinc compound such as zinc borate or zinc hydroxystannate, a metal borate, titanium dioxide, barium sulfate, geopolymers such as alkali aluminosilicate, huntite, hydromagnesite, red phosphorus, boron compounds such as borates, an organic layered silicate, wollastonite, carbonates such as calcium carbonate and magnesium carbonate, iron oxides, lead oxides, strontium chromate, barium sulfate, boron nitride, silicon nitride, aluminum nitride, boron arsenide, silicon dioxide, titanium oxide, zinc oxide, nickel oxide, copper oxide, tin oxide, silicon carbide, agate, emery, diamond, silver, zinc, copper, gold, carbonyl iron, copper, zinc, aluminum, clay, color pigments such as cadmium yellow, cadmium red, chromium yellow, or a combination thereof.

The fire-retardant pigment may have a reported average particle size in at least one dimension of 0.01 microns to 100 microns as reported by the manufacturer, such as 0.01 microns to 50 microns, such as 0.01 microns to 40 microns, such as 0.01 microns to 25 microns, such as 2 microns to 100 microns, such as 2 microns to 50 microns, such as 2 microns to 40 microns, such as 2 microns to 25 microns, such as 10 micron to 100 microns, such as 10 microns to 50 microns, such as 10 microns to 40 microns, such as 10 microns to 25 microns. Suitable methods of measuring average particle size include, for example, measurement using an instrument such as the Quanta 250 FEG SEM or an equivalent instrument.

The fire-retardant pigment may be present in the electrodeposited coating and/or electrodepositable coating composition at a fire-retardant pigment-to-binder (P:B) ratio of at least 0.01:1, such as at least 0.05:1, such as at least 0.1:1, such as at least 0.12:1, such as at least 0.15:1, such as at least 0.17:1. The fire-retardant pigment may be present in the fire-retardant electrodepositable coating composition at a fire-retardant pigment-to-binder (P:B) ratio of less than 0.2:1, such as no more than 0.17:1, such as no more than 0.15:1, such as no more than 0.12:1, such as no more than 0.1:1, such as no more than 0.05:1. The fire-retardant pigment may be present in the fire-retardant electrodepositable coating composition at a fire-retardant pigment-to-binder (P:B) ratio of 0.01:1 to less than 0.2:1, such as 0.01:1 to 0.17:1, such as 0.01:1 to 0.15:1, such as 0.01:1 to 0.12:1, such as 0.01:1 to 0.1:1, such as 0.01:1 to 0.05:1, such as 0.05 to less than 0.2:1, such as 0.05:1 to 0.17:1, such as 0.05:1 to 0.15:1, such as 0.05:1 to 0.12:1, such as 0.05:1 to 0.1:1, such as 0.1:1 to less than 0.2:1, such as 0.1:1 to 0.17:1, such as 0.1:1 to 0.15:1, such as 0.1:1 to 0.12:1, such as 0.12:1 to less than 0.2:1, such as 0.12:1 to 0.17:1, such as 0.12:1 to 0.15:1, such as 0.15:1 to less than 0.2:1, such as 0.15:1 to 0.17:1, such as 0.17:1 to less than 0.2:1.

The electrodeposited coating and/or electrodepositable coating composition may optionally further comprise a binder comprising a hybrid organic-inorganic material. As used herein, the term “hybrid organic-inorganic material” refers to materials that are partially organic and include at least one other atom other than hydrogen, oxygen and/or nitrogen, such as, for example, a halogen, sulfur, phosphorus, silicon, and the like with the exception of melamine derivatives that include such atoms.

The hybrid organic-inorganic material may contribute to the fire-retardancy of a coating deposited from the electrodepositable coating composition.

Non-limiting examples of the hybrid organic-inorganic material includes an organohalogen compound, a phosphorus-containing resin, such as an organophosphorus compound, a silicone resin, a sulfur-containing resin, a nano-gel, or a combination thereof.

Suitable examples of organohalogen compounds include organochlorines such as chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD). Such halogenated materials may be used in conjunction with a synergist to enhance their efficiency. Other suitable examples include antimony trioxide, antimony pentaoxide, and sodium antimonate.

Suitable examples of organophosphorus compounds include triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminum diethyl phosphinate.

The hybrid organic-inorganic material may also comprise compounds that contain both phosphorus and a halogen. Such compounds include tris(2,3-dibromopropyl) phosphate (brominated tris) and chlorinated organophosphates such as tris(1,3-dichloro-2-propyl)phosphate (chlorinated tris or TDCPP) and tetrakis(2-chlorethyl)dichloroisopentyldiphosphate (V6).

The hybrid organic-inorganic material may also comprise ammonium polyphosphate.

The electrodeposited coating and/or electrodepositable coating composition may optionally further comprise an organic fire-retardant additive.

As used herein, the term “organic fire-retardant additive” refers to an organic compound that contributes to the fire-retardancy of a coating, and “organic” in “organic fire-retardant additive” refers to materials that include carbon and optionally further includes hydrogen, oxygen, and/or nitrogen atoms. For clarity, “organic fire-retardant additive” includes melamine and melamine derivatives even if the melamine derivatives include atoms other than carbon, hydrogen, oxygen, and nitrogen.

The organic fire-retardant additive may comprise an organic compound such as a carboxylic acid, a dicarboxylic acid, melamine and derivatives thereof (including those including phosphate), phenoplast resins, and organonitrogen compounds. For example, the organic compound may comprise a carboxylic acid, a dicarboxylic acid, melamine, melamine polyphosphate, melamine poly(zinc)phosphate, melamine poly (aluminum) phosphate, melamine-based hindered amine light stabilizers, a phenoplast resin, expanded graphite, organonitrogen compounds, or a combination thereof.

The electrodeposited coating and/or electrodepositable coating composition may be substantially free, essentially free, or completely free of montmorillonite.

According to the present disclosure, the electrodepositable coating composition may comprise water and/or one or more organic solvent(s). Water can for example be present in amounts of 40% to 90% by weight, such as 50% to 75% by weight, based on total weight of the electrodepositable coating composition. Examples of suitable organic solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic solvents may typically be present in an amount of less than 10% by weight, such as less than 5% by weight, based on total weight of the electrodepositable coating composition. The electrodepositable coating composition may in particular be provided in the form of a dispersion, such as an aqueous dispersion.

According to the present disclosure, the total solids content of the electrodepositable coating composition may be at least 1% by weight, such as at least 5% by weight, and may be no more than 50% by weight, such as no more than 40% by weight, such as no more than 20% by weight, based on the total weight of the electrodepositable coating composition. The total solids content of the electrodepositable coating composition may be from 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110° C. for 15 minutes.

### Substrates

According to the present disclosure, the electrodepositable coating composition may be electrophoretically applied to an electrically conductive substrate. The electrodepositable coating composition may be electrophoretically deposited upon any electrically conductive substrate. Suitable substrates include metal substrates, metal alloy substrates, and/or substrates that have been metallized, such as nickel-plated plastic. Additionally, substrates may comprise non-metal conductive materials including composite materials such as, for example, materials comprising carbon fibers or conductive carbon. According to the present disclosure, the metal or metal alloy may comprise cold rolled steel, hot rolled steel, stainless steel, steel coated with zinc metal, zinc compounds, or zinc alloys, such as electrogalvanized steel, hot-dipped galvanized steel, galvanealed steel, and steel plated with zinc alloy. Aluminum alloys of the 2XXX, 3XXX, 4XXX, 5XXX, 6XXX, or 7XXX series as well as clad aluminum alloys and cast aluminum alloys of the A356 series also may be used as the substrate. Magnesium alloys of the AZ31B, AZ91C, AM60B, or EV31A series also may be used as the substrate. The substrate used in the present disclosure may also comprise titanium and/or titanium alloys. Other suitable non-ferrous metals include copper and magnesium, as well as alloys of these materials. Suitable metal substrates for use in the present disclosure include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, agricultural equipment, lawn and garden equipment, air conditioning units, heat pump units, lawn furniture, and other articles. As used herein, “vehicle” or variations thereof includes, but is not limited to, civilian, commercial and military aircraft, and/or land vehicles such as cars, motorcycles, trucks, tanks, and/or armored cars or trucks. The metal substrate also may be in the form of, for example, a sheet of metal or a fabricated part. It will also be understood that the substrate may be pretreated with a pretreatment solution including a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091.

The substrate may be a multi-metal article. As used herein, the term “multi-metal article” refers to (1) an article that has at least one surface comprised of a first metal and at least one surface comprised of a second metal that is different from the first metal, (2) a first article that has at least one surface comprised of a first metal and a second article that has at least one surface comprised of a second metal that is different from the first metal, or (3) both (1) and (2). The substrate may comprise surfaces or parts of different substrate materials that are adjacent or joined together such as, for example, a galvanic assembly.

### Methods of Coating, Coatings and Coated Substrates

The electrodepositable coating composition may be electrophoretically applied to the electroconductive substrate and at least partially cured using application conditions, times, and temperatures, as known to those skilled in the art.

The cationic electrodepositable coating composition of the present disclosure may be deposited upon an electrically conductive substrate by placing the composition in contact with an electrically conductive cathode and an electrically conductive anode, with the surface to be coated being the cathode. Following contact with the composition, an adherent film of the coating composition may be deposited on the cathode when a sufficient voltage is impressed between the electrodes.

The anionic electrodepositable coating composition of the present disclosure may be deposited upon an electrically conductive substrate by placing the composition in contact with an electrically conductive cathode and an electrically conductive anode, with the surface to be coated being the anode. Following contact with the composition, an adherent film of the coating composition may be deposited on the anode when a sufficient voltage is impressed between the electrodes.

The applied voltage in the electrophoretic application of the electrodepositable coating compositions of the present disclosure, may be varied and may be, for example, as low as one volt to as high as several thousand volts, such as between 50 and 500 volts. The current density may, for example, be between 0.5 ampere and 15 amperes per square foot and tends to decrease during electrodeposition indicating the formation of an insulating film.

The substrate, coated at least in part with an electrodepositable coating layer deposited from the coating compositions of the present disclosure, may be heated to a temperature and for a time sufficient to at least partially cure the electrodeposited coating on the substrate. As used herein, the term “at least partially cure” refers to subjecting the coating composition to curing conditions such that at least a portion of the reactive groups of the components of the coating composition cure or crosslink to form a coating. In general, the substrate may be heated to a temperature ranging from 250° F. to 450° F. (121.1° C. to 232.2° C.), such as from 275° F. to 400° F. (135° C. to 204.4° C.), such as from 300° F. to 360° F. (149° C. to 180° C.). For purposes of the present disclosure, all that is necessary is that the time be sufficient to effect cure of the coating on the substrate. The curing time may, for example, range from 10 minutes to 60 minutes, such as 20 to 40 minutes. The thickness of the resultant cured electrodeposited coating is not limited and may optionally range from 15 to 50 microns.

The present disclosure is also directed to methods for coating a substrate, such as any one of the electroconductive substrates mentioned above. According to the present disclosure such method may comprise electrophoretically applying an electrodepositable coating composition as described above to at least a portion of the substrate and curing the coating composition to form an at least partially cured coating on the substrate. According to the present disclosure, the method may comprise (a) electrophoretically depositing onto at least a portion of the substrate an electrodepositable coating composition of the present disclosure and (b) heating the coated substrate to a temperature and for a time sufficient to cure the electrodeposited coating on the substrate. According to the present disclosure, the method may optionally further comprise (c) applying directly to the at least partially cured electrodeposited coating one or more pigment-containing coating compositions and/or one or more pigment-free coating compositions to form a topcoat over at least a portion of the at least partially cured electrodeposited coating, and (d) heating the coated substrate of step (c) to a temperature and for a time sufficient to cure the topcoat.

The electrodepositable coating compositions of the present disclosure may comprise a multi-layer coating system. The coating layer deposited from the present composition may have one or more additional coating layers deposited under and/or over the layer. In a non-limiting example, the coating system may comprise a pretreatment layer, such as a phosphate layer (e.g., zinc phosphate layer), and the electrodepositable coating composition described in the present disclosure may be deposited over at least a portion of the pretreated layer; one or more additional coating layers may be applied over at least a portion of the electrodeposited coating layer. In addition to the electrodepositable coating composition of the present disclosure, the coating system may include, for example, one or more pretreatment layers, and one or more additional coating layers comprising primers, basecoats, color coats, monocoats, clear coats and/or topcoats. Suitable additional coating layers include any of those known in the art, and each independently may be waterborne, solventborne, in solid particulate form (i.e., a powder coating composition), or in the form of a powder slurry. The additional coating layers may each be cured independently, or optionally applied “wet-on-wet” and cured simultaneously. As used herein, “wet-on-wet” refers to a process, wherein a coating, for example a clear coat, is applied over a substantially uncured different coating, for example a color coat, and both coatings are then cured simultaneously.

The coating system may optionally comprise one, or a mixture of two or more, of any colorants and/or fillers, as known to those skilled in the art, in any coating layer or layers, in any amounts sufficient to impart the desired property, visual and/or color effect.

The present disclosure is further directed to an electrodepositable coating formed by at least partially curing a film from the electrodepositable coating composition described herein.

The present disclosure is also directed to a coated substrate comprising a coating deposited from the electrodepositable coating composition described above.

The coated substrate may be coated by the method described herein.

The coated conductive substrate optionally may not include, or may be free of, a pretreatment layer between the substrate and the electrodeposited coating.

The coated conductive substrate optionally may not include any intervening coating layers between the substrate and the electrodeposited coating.

Moreover, the topcoat layers may be applied directly onto the electrodepositable coating layer. In other words, the substrate may lack a primer layer. For example, a basecoat layer may be applied directly onto at least a portion of the electrodeposited coating layer.

The electrodeposited coating may have a water vapor transmittance rate of less than 55 g/m² per day, as measured by WATER VAPOR TRANSMITTANCE TEST METHOD, such as less than 50 g/m² per day, such as less than 45 g/m² per day, such as less than 40 g/m² per day.

The electrodeposited coating may have an edge coverage of greater than 20%, as measured by the EDGE COVERAGE TEST METHOD, such as greater than 30%, such as greater than 40%, such as greater than 50%, such as greater than 60%, such as greater than 70%, such as greater than 80%, such as greater than 90%, such as greater than 95%.

As used herein, unless otherwise defined herein, the term “substantially free” means the ingredient is present in an amount of 1% by weight or less, based on the total weight of the electrodeposited coating and/or the total solids weight of the electrodepositable coating composition.

As used herein, unless otherwise defined herein, the term “essentially free” means the ingredient is present in an amount of 0.1% by weight or less, based on the total weight of the electrodeposited coating and/or the total solids weight of the electrodepositable coating composition.

As used herein, unless otherwise defined herein, the term “completely free” means the ingredient is not present in the coating composition, i.e., 0.00% by weight, based on the total weight of the electrodeposited coating and/or the total solids weight of the electrodepositable coating composition.

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

In this application, the use of the singular includes the plural and plural encompasses singular, unless specifically stated otherwise. For example, although reference is made herein to “an” ionic salt group-containing film-forming polymer, “a” hydroxyl functional addition polymer, “a” monomer, “an” ionic salt group-containing film-forming polymer, “a” blocked polyisocyanate curing agent, a combination (i.e., a plurality) of these components may be used. In addition, in this application, the use of “or” means “and/or” unless specifically stated otherwise, even though “and/or” may be explicitly used in certain instances.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### Preparation of Resin Systems for Examples 1-9

Preparation of Crosslinker L A blocked polyisocyanate crosslinker, suitable for use in electrodepositable coating resins, was prepared in the following manner. Components 2-6 listed in Table 1, below, were mixed in a flask set up for total reflux with stirring under nitrogen. The mixture was heated to a temperature of 110° C., and Component 1 was added dropwise so that the temperature increased due to the reaction exotherm and was maintained under 110° C. After the addition of Component 1 was complete, Component 7 was added to the heated reaction mixture. A temperature of 110° C. was established in the reaction mixture and the reaction mixture held at temperature until no residual isocyanate was detected by IR spectroscopy. Components 8 and 9 were then added, and the reaction mixture was allowed to stir for 30 minutes and cooled to ambient temperature.

TABLE 1
Components for the preparation of Crosslinker I

| | | Parts-by-weight |
|---|---|---|
| No. | Component | (grams) |
| 1 | Polymeric methylene diphenyl diisocyanate¹ | 1340 |
| 2 | Dibutyl tin dilaurate | 1.4 |
| 3 | Propylene glycol | 76 |
| 4 | Butyl cellosolve | 826 |
| 5 | Bisphenol A - ethylene oxide adduct charge 1 | 490 |
| | (1/6 molar ratio BPA/EtO) | |
| 6 | Butyl carbitol formal charge 1 | 225 |
| 7 | Butyl carbitol formal charge 2 | 29.4 |
| 8 | Dowanol PM (1-methoxy-2-propanol)² | 353.2 |
| 9 | Bisphenol A - ethylene oxide adduct charge 2 | 190.8 |
| | (1/6 molar ratio BPA/EtO) | |

¹Rubinate M, available from Huntsman Corporation.
²1-methoxy-2-propanol available from Dow.

Preparation of a Cationic, Amine-Functionalized, Polyepoxide-Based Resin (Resin System I). A cationic, amine-functionalized, polyepoxide-based polymeric resin, suitable for use in formulating electrodepositable coating compositions, was prepared in the following manner. Components 1-4 listed in Table 2, below, were combined in a flask set up for total reflux with stirring under nitrogen. The mixture was heated to a temperature of 130° C. and allowed to exotherm (170° C. maximum). A temperature of 145° C. was established in the reaction mixture and the reaction mixture was then held for 1.5 hours. Components 5-7 were then introduced into the reaction mixture and a temperature of 100° C. was established in the reaction mixture. Components 8 and 9 were then added to the reaction mixture quickly and the reaction mixture was allowed to exotherm. A temperature of 110° C. was established in the reaction mixture and the reaction mixture held for 1 hour. After the hold, the heating source was removed from the reaction mixture and Component 10 was introduced slowly. The content of the flask was allowed to stir while cooling to room temperature. The resulting Resin Synthesis Product I had a solids content of 86.9% by weight.

TABLE 2
Components for the preparation of Resin System I

| | | Parts-by-weight |
|---|---|---|
| No. | Component | (grams) |
| 1 | Bisphenol A diglycicyl ether¹ | 188 |
| 2 | Bisphenol A | 81.2 |
| 3 | Bisphenol A - ethylene oxide adduct charge 1 | 80.0 |
| | (1/6 molar ratio BPA/EtO) | |
| 4 | Ethyl triphenyl phosphonium iodide | 0.183 |
| 5 | Bisphenol A - ethylene oxide adduct charge 2 | 18.6 |
| | (1/6 molar ratio BPA/EtO) | |
| 6 | Crosslinker I² | 342 |
| 7 | Butyl carbitol formal | 8.50 |
| 8 | Aminopropyl diethanol amine | 6.60 |
| 9 | n-Methyl ethanol amine | 14.4 |
| 10 | Dowanol PM (1-methoxy-2-propanol)³ | 62.0 |

¹Epon 880, available from Hexion Corporation.
²See example Crosslinker I above.
³1-methoxy-2-propanol available from Dow Chemical Company.

Preparation of Crosslinker II. A blocked polyisocyanate crosslinker, suitable for use in electrodepositable coating compositions, was prepared in the following manner. Components 2-4 listed in Table 3, below, were mixed in a flask set up for total reflux with stirring under nitrogen. Component 1 was added to the mixture under nitrogen over 1 hour keeping the temperature under 100° C. After addition of Component 1 was complete, the flask was rinsed with Component 5 and held at 100° C. for one hour. Components 6 and 7 were then added to the flask and the mixture was allowed to mix for 30 minutes and cool to ambient temperature.

TABLE 3
Components for the preparation of Crosslinker II

| | | Parts-by-weight |
|---|---|---|
| No. | Component | (grams) |
| 1 | Polymeric methylene diphenyl diisocyanate¹ | 1340.0 |
| 2 | Dibutyl tin dilaurate | 1.500 |
| 3 | Triethylene glycol monomethyl ether | 1149 |
| 4 | PEG400 Kollisolv | 600.0 |
| 5 | Butyl carbitol formal | 12.00 |
| 6 | Dowanol PM (1-methoxy-2-propanol)² | 161.7 |
| 7 | Bisphenol A - ethylene oxide adduct charge | 132.0 |
| | 2 (1/6 molar ratio BPA/EtO) | |

¹Rubinate M, available from Huntsman Corporation.
²1-methoxy-2-propanol available from Dow.

Preparation of a Cationic, Amine-Functionalized, Polyepoxide-Based Resin (Resin System II). A cationic, amine-functionalized, polyepoxide-based polymeric resin, suitable for use in formulating electrodepositable coating compositions, was prepared in the following manner. Components 1-4 listed in Table 4, below, were combined in a flask set up for total reflux with stirring under nitrogen. The mixture was heated to a temperature of 130° C. and allowed to exotherm (170° C. maximum). A temperature of 145° C. was established in the reaction mixture and the reaction mixture was then held for 1.5 hours. Component 5 was then introduced into the reaction mixture and a temperature of 100° C. was established in the reaction mixture and mixing was allowed for 10 minutes. Components 6 and 7 were then introduced into the reaction mixture and allowed to mix for 10 minutes. Components 8 and 9 were then added to the reaction mixture quickly and the reaction mixture was allowed to exotherm. A temperature of 110° C. was established in the reaction mixture and the reaction mixture held for 1 hour. After the hold, the heating source was removed from the reaction mixture and Component 10 was introduced slowly. The content of the flask was allowed to stir for at least 15 minutes while cooling to room temperature. The resulting Resin Synthesis Product II had a solids content of 86.2% by weight.

TABLE 4
Components for the preparation of Resin System II

| | | Parts-by-weight |
|---|---|---|
| No. | Component | (grams) |
| 1 | Bisphenol A diglycicyl ether¹ | 188 |
| 2 | Bisphenol A | 81.2 |
| 3 | Bisphenol A - ethylene oxide adduct charge | 30.6 |
| | 1 (1/6 molar ratio BPA/EtO) | |
| 4 | Ethyl triphenyl phosphonium iodide | 0.183 |
| 5 | Bisphenol A - ethylene oxide adduct charge | 42.7 |
| | 2 (1/6 molar ratio BPA/EtO) | |
| 6 | Crosslinker II² | 377 |
| 7 | Butyl carbitol formal | 34.2 |
| 8 | Aminopropyl diethanol amine | 6.60 |
| 9 | n-Methyl ethanol amine | 14.4 |
| 10 | Dowanol PM (1-methoxy-2-propanol)³ | 89.3 |

¹Epon 880, available from Hexion Corporation.
²See example Crosslinker II above.
³1-methoxy-2-propanol available from Dow Chemical Company.

Preparation of a Cationic, Amine-Functionalized, Polyepoxide-Based Resin (Resin System III). A cationic, amine-functionalized, polyepoxide-based polymeric resin, suitable for use in formulating electrodepositable coating compositions, was prepared in the following manner. Components 1-3 listed in Table 5, below, were combined in a flask set up for total reflux with stirring under nitrogen. The mixture was heated to a temperature of 130° C. and mixed. Component 4 was added to the mixture and a temperature of 135° C. was established and held for at least 1 hour until a target epoxy equivalent weight of 549 was achieved. Component 5 was then added to the mixture and a temperature of 100° C. was established in the reaction mixture. Components 6 and 7 were then added to the reaction mixture and allowed to exotherm. A temperature of 95° C. was established in the reaction mixture and the mixture was stirred for 3 hours. The contents of the flask were then solubilized into pre-blended Components 8 and 9 and mixed for 30 minutes. Component 10 was then added over 30 minutes. The resulting Resin Synthesis Product III had a solids content of 45% by weight.

TABLE 5
Components for the preparation of Resin System III

| | | Parts-by-weight |
|---|---|---|
| No. | Component | (grams) |
| 1 | Bisphenol A diglycicyl ether¹ | 401.9 |
| 2 | Bisphenol A | 122.5 |
| 3 | Butyl carbitol formal | 58.50 |
| 4 | Ethyl triphenyl phosphonium iodide | 0.400 |
| 5 | Butyl carbitol formal | 100.1 |
| 6 | Jeffamine D2000² | 1449 |
| 7 | Butyl carbitol formal | 60.40 |
| 8 | Lactic acid | 31.00 |
| 9 | Deionized water | 1119 |
| 10 | Deionized water | 249.6 |

¹Epon 880, available from Hexion Corporation.
²Jeffamine D2000, available from Huntsman.

Preparation of a Cationic, Amine-Functionalized, Polyepoxide-Based Resin (Resin System IV). A cationic, amine-functionalized, polyepoxide-based polymeric resin, suitable for use in formulating electrodepositable coating compositions, was prepared in the following manner. Components 1-4 listed in Table 6, below, were combined in a flask set up for total reflux with stirring under nitrogen. The mixture was heated to a temperature of 130° C. and allowed to exotherm (170° C. maximum). A temperature of 145° C. was established in the reaction mixture and the reaction mixture was then held for 1.5 hours. Component 5 was then introduced into the reaction mixture and a temperature of 100° C. was established in the reaction mixture and mixing was allowed for 10 minutes. Component 7 was then introduced into the reaction mixture and allowed to mix for 10 minutes. Components 7 and 8 were then added to the reaction mixture quickly and the reaction mixture was allowed to exotherm. A temperature of 110° C. was established in the reaction mixture and the reaction mixture held for 1 hour. After the hold, the heating source was removed from the reaction mixture and Component 9 was introduced slowly. The content of the flask was allowed to stir for at least 15 minutes while cooling to room temperature. The resulting Resin Synthesis Product II had a solids content of 86.2% by weight.

TABLE 6
Components for the preparation of Resin System IV

| | | Parts-by-weight |
|---|---|---|
| No. | Component | (grams) |
| 1 | Bisphenol A diglycicyl ether¹ | 188 |
| 2 | Bisphenol A | 81.2 |
| 3 | Bisphenol A - ethylene oxide adduct charge | 30.6 |
| | 1 (1/6 molar ratio BPA/EtO) | |
| 4 | Ethyl triphenyl phosphonium iodide | 0.183 |
| 5 | Bisphenol A - ethylene oxide adduct charge | 42.7 |
| | 2 (1/6 molar ratio BPA/EtO) | |
| 6 | Butyl carbitol formal | 34.2 |
| 7 | Aminopropyl diethanol amine | 6.60 |
| 8 | n-Methyl ethanol amine | 14.4 |
| 9 | Dowanol PM (1-methoxy-2-propanol)³ | 45.8 |

¹Epon 880, available from Hexion Corporation.
²1-methoxy-2-propanol available from Dow Chemical Company.

### Preparation of Electrodepositable Coating Composition for Examples 1-5

Sources of Formulation Additives and Chemicals: Chemicals used for formulation of electrocoat baths were obtained from various suppliers. Butyl carbitol formal is commercially available from BASF Corporation (98% purity) under MAZON 1651. Ethylene glycol monobutyl ether (butyl cellosolve) is commercially available from MILLIPORESIGMA/SIGMA-ALDRICH CORPORATION. Dowanol PM was obtained from the Dow Chemical Company at 98% purity. Triethylene glycol monomethyl ether (TGME) was obtained from Sigma-Aldrich Corporation at 98% purity. Sulfamic acid and Phosphoric acid (85 wt. % active in water) were obtained from PPG Industries Inc.

Example 1: A highly pigmented, electrodepositable coating composition was prepared in the following manner. Components 1-3 listed in Table 7, below, were combined in a stainless-steel beaker and mixed under high sheer (2500 RPM using a 1.5-inch Cowles blade powered by a Fawcett air motor Model 103A) for 5 minutes starting at 40° C. The temperature was raised above 60° C. and the mixture was held with the above mixing for one hour after which the degree of the dispersion was determined by a Hegman gauge. To be adequately dispersed, a minimal reading of 5 had to be achieved.

For the dispersion step, a mixture of Components 4-6 was added to the clay/Resin I paste. A temperature of less than 60° C. was established and the dispersion was mixed with a high-lift blade at 1500 RPM for one hour. After dispersing, the dispersion was allowed to cool to ambient temperatures and Component 7 was added to bring the final solids of this dispersed paste to 50% on weight. Component 8 was then added into the dispersed formulation and allowed to mix under ambient temperatures for one hour to complete the feed at high solids. To generate the electrocoat bath composition, the high solids feed was further diluted with Component 9 to 25% solids by weight.

TABLE 7
Components for the preparation of Example 1

| No. | Component | Parts-by-weight (grams) |
|---|---|---|
| 1 | Plate-like pigment¹ | 417.6 |
| 2 | Resin I² | 672.1 |
| 3 | Deionized water | 66.70 |
| 4 | Sulfamic acid | 13.13 |
| 5 | Resin III³ | 257.8 |
| 6 | Deionized water | 621.3 |
| 7 | Deionized water | 204.9 |
| 8 | CP425⁴ | 46.98 |
| 9 | Deionized water | 2,053 |

¹ASP200 clay available from BASF.
²See example Resin System I above.
³See example Resin System III above.
⁴Dibutyltin dioxide paste available from PPG Industries Inc.

Example 2: A highly pigmented, electrodepositable coating composition was prepared in the following manner. Components 1-3 listed in Table 8, below, were combined in a stainless-steel beaker and mixed under high sheer (2500 RPM using a 1.5-inch Cowles blade powered by a Fawcett air motor Model 103A) for 5 minutes starting at 40° C. The temperature was raised above 60° C. and the mixture was held with the above mixing for one hour after which the degree of the dispersion was determined by a Hegman gauge. To be adequately dispersed, a minimal reading of 5 had to be achieved.

For the dispersion step, a mixture of Components 4-6 was added to the clay/Resin I paste. A temperature of less than 60° C. was established and the dispersion was mixed with a high-lift blade at 1500 RPM for one hour. After dispersing, the dispersion was allowed to cool to ambient temperatures and Component 7 was added to bring the final solids of this dispersed paste to 50% on weight. Component 8 was then added into the dispersed formulation and allowed to mix under ambient temperatures for one hour to complete the feed at high solids. The high solids feed was further diluted with Component 9 to 25% solids by weight. To generate the electrocoat bath composition, the bath was heated to 95° F. and Component 10 was added. The electrocoat bath composition was allowed to mix for two hours before repeating the tests post-addition.

TABLE 8
Components for the preparation of Example 2

| No. | Component | Parts-by-weight (grams) |
|---|---|---|
| 1 | Plate-like pigment¹ | 417.6 |
| 2 | Resin I² | 672.1 |
| 3 | Deionized water | 66.70 |
| 4 | Sulfamic acid | 13.13 |
| 5 | Resin III³ | 257.8 |
| 6 | Deionized water | 621.3 |
| 7 | Deionized water | 204.9 |
| 8 | CP425⁴ | 46.98 |
| 9 | Deionized water | 2,053 |
| 10 | 10% Hydroxyl-Functional Addition | 2.870 |
| | Polymer Solution⁵ | |

¹ASP200 clay available from BASF.
²See example Resin System I above.
³See example Resin System III above.
⁴Dibutyltin dioxide paste available from PPG Industries Inc.
⁵10% Solution prepared by stirring 10% by weight POVAL 35-80, commercial from Kuraray Co., in deionized water at 85° C. for 15 minutes, then allowed to cool for 1 hour before use.

Comparative Examples 3-5: Examples 2 through 4 were prepared through the following general procedure. Components 1-3 listed in Table 9, below, were combined in a stainless-steel beaker and mixed under high sheer (2500 RPM using a 1.5-inch Cowles blade powered by a Fawcett air motor Model 103A) for 5 minutes starting at 40° C. The temperature was raised above 60° C. and the mixture was held with the above mixing for one hour after which the degree of the dispersion was determined by a Hegman gauge. To be adequately dispersed, a minimal reading of 5 had to be achieved.

For the dispersion step, a mixture of Components 4-6 was added to the clay/Resin I paste. A temperature of less than 60° C. was established and the dispersion was mixed with a high-lift blade at 1500 RPM for one hour. After dispersing, the dispersion was allowed to cool to ambient temperatures and Component 7 was added. Component 8 was then added into the dispersed formulation and allowed to mix under ambient temperatures for one hour to complete the feed at high solids. To generate the electrocoat bath composition, the high solids feed was further diluted with Component 9 to 25% solids by weight, except for the example 4 which was diluted with component 9 to reach 15% solids.

TABLE 9
Components for the preparation of Comparative Examples 3-5

| | | Comparative | Comparative | Comparative |
|---|---|---|---|---|
| No. | Component | Example 3 | Example 4 | Example 5 |
| 1 | ASP200 clay¹ | 252.0 | 0.0 | 408.0 |
| 2 | Resin I² | 811.1 | 649.9 | 788.0 |
| 3 | Deionized water | 80.50 | 64.40 | 78.20 |
| 4 | Sulfamic acid | 15.84 | 12.67 | 15.39 |
| 5 | Resin III³ | 311.1 | 248.9 | 0.0 |
| 6 | Deionized water | 543.7 | 394.5 | 716.6 |
| 7 | Deionized water | 201.4 | 912.9 | 200.6 |
| 8 | CP425⁴ | 56.76 | 45.74 | 45.92 |
| 9 | Deionized water | 2,016 | 2,082 | 2,007 |

¹ASP200 clay available from BASF.
²See example Resin System I above.
³See example Resin System III above.
⁴Dibutyltin dioxide paste available from PPG Industries Inc.

### Test Methods for Evaluating Examples 1-5

Evaluation of Burr Edge Coverage: CRS panels pretreated with zinc phosphate (C700/DI; item number 28630 available from ACT, Hillsdale, MI.) were cut in half to yield a 4″ by 6″ panel. Then, 0.25 inches were removed from one side of the panel resulting in a panel that was 3.75″ by 6″ with burred edges on each side. These burred edges serve to test the ability of the electrocoat to cover a sharp edge site. This panel was submerged in the electrocoat, and electrodeposition was carried out using a rectifier (Xantrax Model XFR600-2, Elkhart, Indiana, or Sorensen XZG 300-5.6, Ameteck, Berwyn, Pennsylvania) which was DC-power supplied. The target film build was 1.0 mils (25.4 microns) on the vertical face of the panel. Exact coating conditions for each paint are found in Table 10. After panels were electrocoated, these panels were rinsed with deionized water and baked at 177° C. for 30 minutes in an electric oven (Despatch Model LFD-1-42).

Three panels coated with each electrocoat composition were placed in ASTM-B117 neutral salt-spray corrosion testing with the burred edge facing upward for a total of 7 days (168 hours). After testing, panels were rinsed with isopropyl alcohol to remove residual water and air dried. The amount of corrosion along the burr edge was then measured and is reported in Table 11. Corrosion was quantified by measuring by hand the total length of the burr edge which displays no red rust and is protected from corrosion. The uncorroded length is divided by the total length of the burr edge to provide a percentage of the edge which was covered. This test method is referred to herein as the EDGE COVERAGE TEST METHOD.

Evaluation of Elongation Flexibility: CRS panels pretreated with zinc phosphate (C700/DI; item number 28630 available from ACT, Hillsdale, MI.) were cut in half to yield a 4″ by 6″ panel. These panels were submerged in the electrocoat, and electrodeposition was carried out using a rectifier (Xantrax Model XFR600-2, Elkhart, Indiana, or Sorensen XZG 300-5.6, Ameteck, Berwyn, Pennsylvania) which was DC-power supplied. The target film build was 1.0 mils (25.4 microns) on the vertical face of the panel. Exact coating conditions for each paint are found in Table 10. After panels were electrocoated, these panels were rinsed with deionized water and baked at 177° C. for 30 minutes in an electric oven (Despatch Model LFD-1-42).

Two panels coated with each electrocoat composition were used for elongation flexibility testing through use of a Mandrel bend based on ASTM D522. The panels were placed vertically into the instrument, locked in place, and bent over the conical fulcrum of the instrument. Tape was repeatedly applied to the bent area and pulled off to remove any weakly adhered coating until no additional coating stuck to the tape. The delaminated area was measured by ruler from the edge of the bent area to where the coating no longer delaminated. The amount of delamination along the conical bend is reported in Table 11.

Evaluation of Coating Glass Transition Temperature: To obtain the glass transition temperatures, a conductive electrocoat was first used to generate free films of the example electrocoats. The formulation and use of the conductive electrocoat is detailed in the following.

The conductive electrocoat is made using commercially available PPG products under product codes CR756 and CP639. Deionized water (1959 g) was added to 2093 g of CR756 and 220 g of CP639 paste under agitation for one hour. This material was then used to electrocoat panels using the technical bulletin specifications.

CRS panels pretreated with zinc phosphate (C700/DI; item number 28630 available from ACT, Hillsdale, MI.) were cut in half to yield a 4″ by 6″ panel. These panels were submerged in the conductive electrocoat, and electrodeposition was carried out using a rectifier (Xantrax Model XFR600-2, Elkhart, Indiana, or Sorensen XZG 300-5.6, Ameteck, Berwyn, Pennsylvania) which was DC-power supplied. The target film build was 0.5-0.7 mils (12.7-17.8 microns) on the vertical face of the panel. To achieve the target film build per panel, the electrocoat bath was maintained at 80° F. and used 115 volts with a 0.75 amp limit set. Coating continued until 40 coulombs were generated. After panels were electrocoated, these panels were rinsed with deionized water and baked at 219° C. for 90 minutes in an electric oven (Despatch Model LFD-1-42).

The panels coated in the conductive electrocoat were then submerged in the example electrocoats and electrodeposition was carried out using a rectifier (Xantrax Model XFR600-2, Elkhart, Indiana, or Sorensen XZG 300-5.6, Ameteck, Berwyn, Pennsylvania) which was DC-power supplied. The target film build was 1.0 mils (25.4 microns) on the vertical face of the panel. Exact coating conditions for each paint are found in Table 10. After panels were electrocoated, these panels were rinsed with deionized water and baked at 177° C. for 30 minutes in an electric oven (Despatch Model LFD-1-42). The example electrocoat was then peeled off from the conductive electrocoat panel and used to measure glass transition temperature.

Glass transition temperatures (T_{g}) were measured using a dynamic mechanical analyzer (DMA). A TA Instruments Discovery DMA 850 apparatus was employed in tensile mode with a preload force of 10 mN, amplitude of 15 μm (tensile strain <0.3%), static stress/dynamic stress amplitude ratio (“force tracking”) of 125%, and an oscillation frequency of 1 Hz. The samples were first cut into a rectangular shape, featuring a width of 7 mm, gauge length of 15 mm, and thickness of 25 μm. After loading each film specimen at room temperature under tensile stress, they were cooled to −125° C., thermally equilibrated, and ramped to 200° C. at 3° C./min. The T_{g}s were determined by peak temperature value of loss tangent (tan δ).” Measured T_{g}s are listed in Table 11.

Evaluation of Cured Coating Structure: CRS panels pretreated with zinc phosphate (C700/DI; item number 28630 available from ACT, Hillsdale, MI.) were cut in half to yield a 4″ by 6″ panel. These panels were submerged in the electrocoat, and electrodeposition was carried out using a rectifier (Xantrax Model XFR600-2, Elkhart, Indiana, or Sorensen XZG 300-5.6, Ameteck, Berwyn, Pennsylvania) which was DC-power supplied. The target film build was 1.0 mils (25.4 microns) on the vertical face of the panel. Exact coating conditions for each paint are found in Table 10. After panels were electrocoated, these panels were rinsed with deionized water and baked at 177° C. for 30 minutes in an electric oven (Despatch Model LFD-1-42).

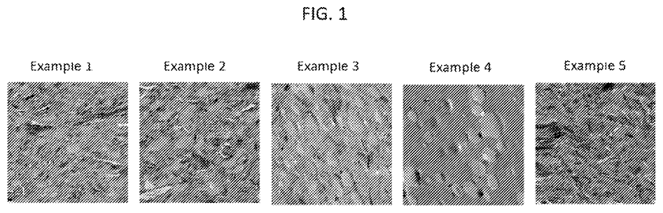

The panels were then prepared for TEM analysis. Panels were cut down to size and embedded in EMBed-812 epoxy and cured at 60° C. for 24 hrs. Thin sections (<80 nm) were then ultra-microtomed and collected on Cu TEM grids. Brightfield images were acquired on the Tecnai T20 TEM operating at 200 kV and images for each of Examples 1-5 are included in FIG. 1. The max Feret diameter of the low-density domains was determined by measuring 10 domains, in three different images, using ImageJ. Measured domain sizes are listed in Table 11.

### Evaluation of Examples 1-5

As demonstrated by Tables 10 and 11, electrodeposited coating having a loading of plate-like pigment at a pigment-to-binder ratio of at least 0.4:1 along with multiple T_{g}s indicative of resinous domain formation, resulted in improved edge corrosion resistance and elongation flexibility. Further, the size of these domains can be tuned to modify these properties.

TABLE 10
Electrodeposition conditions for Examples 1-5

| | | | Compar- | Compar- | Compar- |
|---|---|---|---|---|---|
| | | | ative | ative | ative |
| Condition | Example 1 | Example 2 | Example 3 | Example 4 | Example 5 |
| Voltage (V) | 250 | 250 | 110 | 150 | 285 |
| Current | 0.5 | 0.5 | 0.5 | 0.5 | 0.5 |
| (Amps) | | | | | |
| Time | 2 | 2 | 2 | 2 | 2 |
| (minutes) | | | | | |

TABLE 11
Evaluation of electrodeposited coating compositions for Examples 1-5

| Evaluation | | | Comparative | Comparative | Comparative |
|---|---|---|---|---|---|
| Method | Example 1 | Example 2 | Example 3 | Example 4 | Example 5 |
| P:B | 0.6 | 0.6 | 0.3 | 0 | 0.6 |
| Burr Edge | 72 | 97 | 15 | 0 | 0 |
| Protection (%) | | | | | |
| Mandrel Bend | 2 | 3 | 1 | 0 | 20 |
| Protection (mm) | | | | | |
| T_{g}1; T_{g}2; Tg3 | 100; −21; −65 | 101; −30; −67 | 96; −33; −64 | 93; −18; −60 | 106; No T_{g}2; −68 |
| (° C.) | | | | | |
| Domain Size (nm) | 403 | 575 | 637 | 830 | No domains |

### Preparation of Electrodepositable Coating Compositions for Examples 6-9

Comparative Examples 6 and Example 7: A highly pigmented, electrodepositable coating composition was prepared in the following manner. Components 1-4 listed in Table 12, below, were combined in a stainless-steel beaker and mixed under high sheer (2500 RPM using a 1.5-inch Cowles blade powered by a Fawcett air motor Model 103A) for 5 minutes starting at 40° C. The temperature was raised above 60° C. and the mixture was held with the above mixing for one hour after which the degree of the dispersion was determined by a Hegman gauge. To be adequately dispersed, a minimal reading of 5 had to be achieved.

For the dispersion step, a mixture of Components 5 and 6 were added to the clay/Resin II paste. A temperature of less than 60° C. was established and the dispersion was mixed with a high-lift blade at 1500 RPM for one hour. After dispersing, the dispersion was allowed to cool to ambient temperatures and Components 7 and 8 were added and mixed for one hour to bring the final solids of this dispersed paste to 40% on weight. Component 9 was then added into the dispersed formulation and allowed to mix under ambient temperatures for one hour to complete the feed at high solids. To generate the electrocoat bath composition, the high solids feed was further diluted with Component 10 to 25% solids by weight.

TABLE 12
Components for the preparation of
Comparative Example 6 and Example 7

| | | Comparative | |
|---|---|---|---|
| No. | Component | Example 6 | Example 7 |
| 1 | ASP200 clay¹ | 435 | 439 |
| 2 | Resin II² | 837 | 707 |
| 3 | Phosphoric acid | 6.05 | 5.09 |
| 4 | Deionized water | 83.4 | 70.2 |
| 5 | Sulfamic acid | 10.2 | 8.57 |
| 6 | Deionized water | 765.2 | 700.4 |
| 7 | Resin III³ | 0 | 271.1 |
| 8 | Deionized water | 801 | 724 |
| 9 | E6278⁴ | 28.7 | 26.9 |
| 10 | Deionized water | 1780 | 1792 |

¹ASP200 clay available from BASF.
²See example Resin System II above.
³See example Resin System III above.
⁴Dibutyltin dioxide paste available from PPG Industries Inc.

Comparative Example 8: A highly pigmented, electrodepositable coating composition was prepared in the following manner. Components 1-4 listed in Table 13, below, were combined in a stainless-steel beaker and mixed under high sheer (2500 RPM using a 1.5-inch Cowles blade powered by a Fawcett air motor Model 103A) for 5 minutes starting at 40° C. The temperature was raised above 60° C. and the mixture was held with the above mixing for one hour after which the degree of the dispersion was determined by a Hegman gauge. To be adequately dispersed, a minimal reading of 5 had to be achieved.

For the dispersion step, a mixture of Components 5 and 6 were added to the clay/Resin II/Resin IV paste. A temperature of less than 60° C. was established and the dispersion was mixed with a high-lift blade at 1500 RPM for one hour. The final solids of this dispersed paste is 30% on weight. Component 7 was then added into the dispersed formulation and allowed to mix under ambient temperatures for one hour to complete the feed at high solids. To generate the electrocoat bath composition, the high solids feed was further diluted with Component 8 to 25% solids by weight.

TABLE 13
Components for the preparation of Comparative Examples 8

| No. | Component | Comparative Example 8 |
|---|---|---|
| 1 | Resin II² | 597 |
| 2 | Resin IV³ | 494 |
| 3 | Phosphoric acid | 8.35 |
| 4 | Deionized water | 115 |
| 5 | Sulfamic acid | 14.1 |
| 6 | Deionized water | 2176 |
| 7 | E6278⁴ | 40.3 |
| 8 | Deionized water | 689 |

¹ASP200 clay available from BASF.
²See example Resin System II above.
³See example Resin System IV above.
⁴Dibutyltin dioxide paste available from PPG Industries Inc.

Comparative Example 9: A highly pigmented, electrodepositable coating composition was prepared in the following manner. Components 1-3 listed in Table 14, below, were combined in a stainless-steel beaker and mixed under high sheer (2500 RPM using a 1.5-inch Cowles blade powered by a Fawcett air motor Model 103A) for 5 minutes starting at 40° C. The temperature was raised above 60° C. and the mixture was held with the above mixing for one hour after which the degree of the dispersion was determined by a Hegman gauge. To be adequately dispersed, a minimal reading of 5 had to be achieved.

For the dispersion step, a mixture of Components 4 and 5 were added to the clay/Resin II paste. A temperature of less than 60° C. was established and the dispersion was mixed with a high-lift blade at 1500 RPM for one hour. After dispersing, the dispersion was allowed to cool to ambient temperatures and Component 6 was added and mixed for one hour to bring the final solids of this dispersed paste to 30% on weight. Component 7 was then added into the dispersed formulation and allowed to mix under ambient temperatures for one hour to complete the feed at high solids. To generate the electrocoat bath composition, the high solids feed was further diluted with Component 8 to 25% solids by weight.

TABLE 14
Components for the preparation of Comparative Example 9

| | | Comparative |
|---|---|---|
| No. | Component | Example 9 |
| 1 | Resin II² | 984 |
| 2 | Phosphoric acid | 7.09 |
| 3 | Deionized water | 98.8 |
| 4 | Sulfamic acid | 11.9 |
| 5 | Deionized water | 1982 |
| 6 | Resin III³ | 378 |
| 7 | E6278⁴ | 41.0 |
| 8 | Deionized water | 700 |

¹ASP200 clay available from BASF.
²See example Resin System II above.
³See example Resin System III above.
⁴Dibutyltin dioxide paste available from PPG Industries Inc.

### Test Methods for Evaluating Examples 6-9

Evaluation of Elongation Flexibility: The same testing that was used to evaluate elongation flexibility for examples 1-5 was used for examples 6-9.

Evaluation of Cured Coating Structure: The same testing that was used to evaluate resin domain formation in the cured coating structure for examples 1-5 was used for examples 6-9. However, for examples 6-9 domain formation was either reported as being present in the coating structure or not present in the coating structure.

Evaluation of Coating Water Vapor Transmittance Rate: To obtain the water vapor transmittance rate, a conductive electrocoat was first used to generate free films of the examples 6-9 electrocoats. The formulation and use of the conductive electrocoat is detailed in the following.

The conductive electrocoat is made using commercially available PPG products under product codes CR756 and CP639. Deionized water (1959 g) was added to 2093 g of CR756 and 220 g of CP639 paste under agitation for one hour. This material was then used to electrocoat panels using the technical bulletin specifications.

CRS panels pretreated with zinc phosphate (C700/DI; item number 28630 available from ACT, Hillsdale, MI.) were cut in half to yield a 4″ by 6″ panel. These panels were submerged in the conductive electrocoat, and electrodeposition was carried out using a rectifier (Xantrax Model XFR600-2, Elkhart, Indiana, or Sorensen XZG 300-5.6, Ameteck, Berwyn, Pennsylvania) which was DC-power supplied. The target film build was 0.5-0.7 mils (12.7-17.8 microns) on the vertical face of the panel. To achieve the target film build per panel, the electrocoat bath was maintained at 80° F. and used 115 volts with a 0.75 amp limit set. Coating continued until 40 coulombs were generated. After panels were electrocoated, these panels were rinsed with deionized water and baked at 219° C. for 90 minutes in an electric oven (Despatch Model LFD-1-42).

The panels coated in the conductive electrocoat were then submerged in the example electrocoats and electrodeposition was carried out using a rectifier (Xantrax Model XFR600-2, Elkhart, Indiana, or Sorensen XZG 300-5.6, Ameteck, Berwyn, Pennsylvania) which was DC-power supplied. The target film build was 1.0 mils (25.4 microns) on the vertical face of the panel. Exact coating conditions for each paint are found in Table 15. After panels were electrocoated, these panels were rinsed with deionized water and baked at 177° C. for 30 minutes in an electric oven (Despatch Model LFD-1-42). The example electrocoat was then peeled off from the conductive electrocoat panel and used to measure glass transition temperature.

Water vapor transmittance rates were measured following ASTM F-1249 using a Permatran-W 3/34 WVTR Analyzer. Each sample was masked between two pieces of adhesive aluminum foil. The testing area was 5.00 cm² with samples tested at 37.8° C. and 90% room humidity. The test method is referred to herein as the WATER VAPOR TRANSMITTANCE TEST METHOD. Measured transmittance rates for examples 6-9 are listed in Table 16.

### Evaluation of Examples 6-9

The results shown in Table 16 demonstrate the effectiveness of utilizing plate like pigments in combinations with domains in the coating structure to provide a balanced improvement in reducing water vapor transmission as well as improving elongation flexibility of the coating.

TABLE 15
Electrodeposition conditions for Examples 6-9

| | Comparative | | Comparative | Comparative |
|---|---|---|---|---|
| Condition | Example 6 | Example 7 | Example 8 | Example 9 |
| Voltage (V) | 298 | 200 | 100 | 50 |
| Current | 0.5 | 0.5 | 0.5 | 0.5 |
| (Amps) | | | | |
| Time | 2 | 2 | 2 | 2 |
| (minutes) | | | | |

TABLE 16
Evaluation of electrodeposited coating
compositions for Examples 6-9

| | Comparative | Exam- | Comparative | Comparative |
|---|---|---|---|---|
| Evaluation Method | Example 6 | ple 7 | Example 8 | Example 9 |
| Platy Pigment P:B | 0.6 | 0.6 | 0 | 0 |
| Domains Present in | No | Yes | No | Yes |
| Coating Structure | | | | |
| Mandrel Bend | 25 | 5 | 0 | 0 |
| Protection (mm) | | | | |
| Water Vapor | 22.2 | 39.9 | 60.8 | 177 |
| Transmittance Rate | | | | |
| (g/m² per day) | | | | |

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. A coated electrically conductive substrate comprising an electrodeposited coating deposited from an electrodepositable coating composition, wherein the electrodeposited coating comprises:
a plate-like pigment present in a pigment-to-binder ratio of at least 0.4:1; and
an electrodeposited binder comprising:
a first resin domain having a first glass transition temperature; and
a second resin domain having a second glass transition temperature, wherein the first glass transition temperature is at least 10° C. greater than the second glass transition temperature, and the second glass transition temperature is greater than −50° C.

2. The coated electrically conductive substrate of claim 1, wherein the first glass transition temperature is at least 80° C.; and the second glass transition temperature is from −50° C. to 70° C.

3-4. (canceled)

5. The coated electrically conductive substrate of claim 1, wherein the plate-like pigment has an average equivalent spherical diameter of at least 50 nm.

6. The coated electrically conductive substrate of claim 1, wherein the plate-like pigment comprises a phyllosilicate pigment, wherein optionally the phyllosilicate pigment comprises mica, chlorite, serpentine, talc, a clay mineral, or a combination thereof, wherein optionally the clay mineral comprises kaolin clay, smectite clay, or a combination thereof.

7. (canceled)

8. The coated electrically conductive substrate of claim 1, wherein the electrodeposited binder comprises an organic binder comprising the residue of an active hydrogen-containing, ionic salt group-containing film-forming polymer, a curing agent, and at least one organic resinous component different than the active hydrogen-containing, ionic salt group-containing film-forming polymer and curing agent.

9. (canceled)

10. The coated electrically conductive substrate of claim 8, wherein the organic resinous component comprises (1) an addition polymer comprising a polymerization product of a polymeric dispersant and a second stage ethylenically unsaturated monomer composition comprising a second stage hydroxyl-functional (meth)acrylamide monomer and/or a second stage hydroxyl-functional (meth)acrylate monomer; (2) a hydroxyl-functional addition polymer comprising constitutional units, at least 70% of which comprise formula VIII: 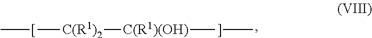
wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group, and the % based upon the total constitutional units of the hydroxyl-functional addition polymer; (3) a cellulose derivative; (4) polyvinyl formamide; (5) a cationic epoxy microgel; (6) a polyamine-dialdehyde adduct; (7) a polyetheramine adduct; or any combination thereof.

11-12. (canceled)

13. The coated electrically conductive substrate of claim 8, wherein the organic resinous component comprises a hydroxyl-functional addition polymer.

14-15. (canceled)

16. The coated electrically conductive substrate of claim 8, wherein the organic resinous component comprises a polyetheramine adduct.

17-18. (canceled)

19. The coated electrically conductive substrate of claim 1, wherein the second resin domain is present as a visible disruption in the homogeneity of the binder as determined by TEM ANALYSIS METHOD.

20. The coated electrically conductive substrate of claim 1, wherein the second resin domain has a domain size of at least 50 nm, such as at least 100 nm, such as at least 150 nm, such as at least 200 nm, such as at least 250 nm, such as at least 300 nm, such as at least 350 nm, such as at least 400 nm, such as at least 450 nm, such as at least 500 nm, such as at least 550 nm, such as at least 600 nm, such as at least 650 nm, such as at least 700 nm, such as at least 750 nm, such as at least 800 nm.

21. The coated electrically conductive substrate of claim 1, wherein the electrodeposited coating has delamination of less than 15 mm when measured according to the mandrel bend test according to ASTM D522; and/or
wherein the electrodeposited coating has an edge coverage of greater than 20%, as measured by the EDGE COVERAGE TEST METHOD; and/or
wherein the electrodeposited coating has water vapor transmittance rate of less than 55 g/m² per day, as measured by WATER VAPOR TRANSMITTANCE TEST METHOD.

22. The coated electrically conductive substrate of claim 1, wherein the electrodeposited coating further comprises a third glass transition temperature that is less than the second glass transition temperature.

23-24. (canceled)

25. The coated electrically conductive substrate of claim 1, wherein the electrodeposited coating further comprises a fire-retardant pigment, a hybrid organic-inorganic material, and/or an organic fire-retardant additive.

26. An electrodepositable coating composition comprising:
an electrodepositable binder comprising an active hydrogen-containing, ionic salt group-containing film-forming polymer; a curing agent; and at least one organic resinous component different than the active hydrogen-containing, ionic salt group-containing film-forming polymer and curing agent; and
a plate-like pigment present in a pigment-to-binder ratio of at least 0.4:1.

27-32. (canceled)

33. The electrodepositable coating composition of claim 26, wherein the organic resinous component comprises (1) an addition polymer comprising a polymerization product of a polymeric dispersant and a second stage ethylenically unsaturated monomer composition comprising a second stage hydroxyl-functional (meth)acrylamide monomer and/or a second stage hydroxyl-functional (meth)acrylate monomer; (2) a hydroxyl-functional addition polymer comprising constitutional units, at least 70% of which comprise formula VIII: 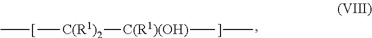
wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group, and the % based upon the total constitutional units of the hydroxyl-functional addition polymer; (3) a cellulose derivative; (4) polyvinyl formamide; (5) a cationic epoxy microgel; (6) a polyamine-dialdehyde adduct; (7) a polyetheramine adduct; or any combination thereof.

34-35. (canceled)

36. The electrodepositable coating composition of claim 26, wherein the organic resinous component comprises a hydroxyl-functional addition polymer.

37-38. (canceled)

39. The electrodepositable coating composition of claim 26, wherein the organic resinous component comprises a polyetheramine adduct.

40-41. (canceled)

42. The electrodepositable coating composition of claim 26, further comprising a fire-retardant pigment.

43. A method of coating an electrically conductive substrate comprising electrophoretically applying a coating deposited from the electrodepositable coating composition of claim 26 to at least a portion of the electrically conductive substrate.
